(19) United States
(12) Patent Application Publication
(10) Pub. No.: US 2025/0316152 A1
(43) Pub. Date: Oct. 9, 2025

(54) TAMPER-RESISTANT CONTAINER

(71) Applicant: Legitimate, Inc., New York, NY (US)

(72) Inventors: Jia Dan Duan, New York, NY (US); Calvin Ho-Yin Chan, New York, NY (US)

(21) Appl. No.: 19/062,898

(22) Filed: Feb. 25, 2025

Related U.S. Application Data
(63) Continuation-in-part of application No. 19/035,200, filed on Jan. 23, 2025.
(60) Provisional application No. 63/574,931, filed on Apr. 5, 2024.
(60) Provisional application No. 63/704,166, filed on Oct. 7, 2024.
(60) Provisional application No. 63/719,965, filed on Nov. 13, 2024.

(51) Int. Cl. G08B 13/12; B65D 25/20; B65D 55/06; G06K 19/07

(52) U.S. Cl. CPC G08B 13/126; B65D 25/205; B65D 55/06; G06K 19/0723

(57) ABSTRACT

An apparatus for securely holding an item includes a case having a closeable pouch defining an interior volume configured to hold the item, and a tamper-detecting near field communications (“NFC”) tag secured to the case and configured to change a state in response to an opening of the case after the NFC tag has been applied, where the NFC tag is configured to transmit information indicating the change of state.

### RELATED APPLICATIONS

This application is a Continuation-In-Part of U.S. Non-Provisional patent application Ser. No. 19/035,200, filed Jan. 23, 2025 and titled “System and Method for Encrypted NFC Communication” and naming Calvin Ho-Yin Chan and Jia Dan Duan as inventors [Attorney Docket No. 125501-10104] and claims priority to U.S. Provisional Application No. 63/704,166, filed Oct. 7, 2024 and titled “System and Method for Encrypted NFC Communication” and naming Calvin Ho-Yin Chan and Jia Dan Duan as inventors [Attorney Docket No. 125501-10103] and claims priority to U.S. Provisional Application No. 63/719,965, filed Nov. 13, 2024 and titled “Tamper-Resistant Container” [Attorney Docket No. 125501-10201] and to U.S. Provisional Application No. 63/574,931, filed Apr. 5, 2024 and titled “Management of Physical or Virtual Items” and naming Calvin Ho-Yin Chan and Jia Dan Duan as inventors [Attorney Docket No. 125501-10101].

The disclosure of each of the foregoing is incorporated herein by reference, in its entirety.

### FIELD

Illustrative embodiments of the invention generally relate to containers and, more particularly, various embodiments of the invention relate to tamper-resistant containers.

### BACKGROUND

Near Field Communication (NFC) is a short-range wireless technology that allows devices to communicate with each other when they are placed within close proximity, typically just a few centimeters apart. This technology operates on the principles of electromagnetic induction, enabling data transfer between compatible devices without the need for physical connections. NFC is commonly used in contactless payment systems, where users can simply tap their smartphones or smart cards against a payment terminal to complete transactions swiftly and securely. Additionally, NFC enables functionalities like data sharing, device pairing, and access control, making it a versatile tool in various applications, from public transportation to ticketing.

One of the standout features of NFC is its convenience and ease of use. The technology requires minimal user interaction, often involving just a single tap or touch, which streamlines everyday activities. NFC-enabled devices can also operate in different modes, such as reader mode for scanning tags, peer-to-peer mode for sharing files, and card emulation mode for acting as a smart card. This flexibility has led to its adoption in smartphones, wearables, and IoT devices, facilitating seamless interactions in both personal and commercial contexts. As the demand for contactless solutions continues to rise, NFC is becoming an integral part of our digital ecosystem, enhancing user experiences and promoting efficient communication.

One application of near field communication is in communication between a tag (or “NFC tag”) and a reader. For example, an NFC tag may send a message to a reader, but the reader (or the proprietor of the reader) may wish to authenticate that the message is actually from the NFC tag from which the message purports to originate. To that end, some NFC tags and readers employ asymmetric encryption, but asymmetric encryption by an NFC tag undesirably consumes more power (from the NFC tag's limited power resources) than symmetric encryption.

### SUMMARY OF VARIOUS EMBODIMENTS

Illustrative embodiments are described in the listing of innovations, below. A first embodiment includes an apparatus for securely holding an item, the apparatus including:
a case having an interior volume configured to hold the item, and a closeable opening; and
a first tamper-detecting near field communications (“NFC”) tag secured to the case and configured to provide output data in response to a query from an NFC reader, said output data including:
   first state data at a first time, which first time occurs after the NFC tag has been applied and before the case has been opened; and
   second state data at a second time, which second time occurs after the first time and after the case has been opened, wherein said second state data indicates that the case has been opened and is indicative of the change of state.

In some embodiments, the case has a pouch for holding the first tamper-detecting NFC tag within the case, said pouch distinct from the interior volume.

In some embodiments, the case has a plurality of sides, and:
the first tamper-detecting NFC tag is disposed to detect opening of a first side of the case; and the apparatus further includes:
a second tamper-detecting near field communications (“NFC”) tag secured to the case and disposed to detect opening of a second side of the case, the second side distinct from the first side.

In some embodiments, the case has a plurality of sides, and the first tamper-detecting NFC tag is disposed on the case so as to be configured to detect opening of at least two edges or seams of the case.

In some embodiments, the first tamper-detecting NFC tag includes a wire configured to be disposed at an edge of the case, which wire, when broken, causes the first tamper-detecting NFC tag to change its output data to indicate a change of state from a first state data to a second state.

In some embodiments, the first tamper-detecting NFC tag includes a
wire configured to be disposed at a plurality of edges of the case, which wire, when broken, causes the first tamper-detecting NFC tag to change its output data from a first state to second state.

In some embodiments, the first tamper-detecting NFC tag includes a plurality of wires, each wire configured to be disposed near a corresponding edge or seam of the case, each wire when broken, causes the first tamper-detecting NFC tag to change its output data from first state data to second state data.

In some embodiments, the first tamper-detecting NFC tag is disposed within the interior volume along with the item.

In some embodiments, the first tamper-detecting NFC tag is configured to cause a reader to cause display, on a computer screen in response to the tamper-detecting NFC tag being read by the reader, of a digital experience, the digital experience including information describing an item confined within the interior volume. In some such embodiments, information describing the item includes a name of the item confined within the interior volume. In some such embodiments, the information describing the item includes an image of the item confined within the interior volume. In some such embodiments, the item confined within the interior volume is a collectable item and the information describing the item includes an association of the collectable item with a celebrity. In some such embodiments, the information describing the item confined within the interior volume includes a photograph of an act of sealing the item into the interior volume. In some such embodiments, the information describing the item confined within the interior volume includes a video of an act of sealing the item into the interior volume.

Another embodiment includes an apparatus for securely holding an item, the apparatus including:
a case having a closeable opening defining an interior volume, said volume configured to hold the item when the opening is in a closed state; and
a wire disposed within the case, the wire having:
   a first end not coupled to a first bonding pad of an NFC tag but configured to electrically couple to said first bonding pad of an NFC tag, and
   a second end configured to electrically couple to a second bonding pad of the NFC tag,
wherein the wire is configured to configure the NFC tag into a tamper-detecting NFC tag by providing an electrical connection between the first bonding pad and the second bonding pad.

In some such embodiments, when the NFC tag is coupled to the case to cover to the closeable opening, and the first end of the wire is electrically coupled to the first bonding pad and the second end of the wire is electrically coupled to the second bonding pad, the NFC tag is configured to transmit information indicating a subsequent opening of the closeable opening.

In some embodiments, the wire configured to be disposed at a plurality of edges of the case so as to detect opening of the case at any of said edges.

In some embodiments, the wire is configured to couple to a particular NFC tag, which particular NFC tag is specifically associated with a particular item disposed within the interior volume.

In some embodiments, the particular NFC tag is configured to cause a reader to cause display, on a computer screen in response to being read by the reader, of a digital experience, the digital experience including information describing the particular item.

In some embodiments, the particular NFC tag includes a memory storing information identifying an owner of the particular item, and the digital experience includes said information identifying said owner of the particular item.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIG. 1A schematically illustrates an object coupled to a near-field communications tag;

FIG. 1B schematically illustrates a near-field communications tag in wireless communication with a near-field communications reader;

FIG. 2 is a flowchart illustrating a method of a tag creating an encrypted message;

FIG. 3 schematically illustrates an embodiment of a Merkle tree;

FIG. 4 is a flowchart illustrating an embodiment of method of forming a Merkle tree corresponding to a particular near field communications tag;

FIG. 5 is a flowchart illustrating an embodiment of method of authenticating an encrypted message at a receiver;

FIG. 6 is a flowchart illustrating an embodiment of method of authenticating an encrypted message at a receiver, which message is from an NFC tag associated with a physical object;

FIG. 7 schematically illustrates a reader in communication with a blockchain processor;

FIG. 8 is a flowchart illustrating an embodiment of method of providing a reward to a user;

FIG. 9A, FIG. 9B, FIG. 9C and FIG. 9D schematically illustrate embodiments of conditional transfers;

FIG. 10A schematically illustrates an embodiment of a tamper-resistant (or tamper-detecting) container;

FIG. 10B schematically illustrates an embodiment of a tamper-resistant container;

FIG. 10C schematically illustrates an embodiment of a tamper-resistant container; and

FIG. 11A and FIG. 11B schematically illustrate an embodiment of a tamper-resistant container.

### DESCRIPTION OF ILLUSTRATIVE EMBODIMENTS

In some illustrative embodiments, a container for an item is rendered tamper resistant by sealing it with a tamper-proof seal.

Some illustrative embodiments provide systems and methods that enable a reader to authenticate a message from an NFC tag without decrypting any portion of the message. Indeed, in some embodiments, a reader authenticating a message does not possess, or even have access to, an encryption key used by the NFC tag in creation of the message.

Illustrative embodiments enable an NFC tag to create a message using asymmetric encryption.

Illustrative embodiments enable an NFC tag to create a message using symmetric encryption, which beneficially requires less power than asymmetric encryption.

Moreover, illustrative embodiments enable an owner of the encryption key to enable encrypted communication between an NFC tag and an NFC reader, without the owner having to share the encryption key with the NFC reader.

Details of illustrative embodiments are discussed below.

Definitions: As used in this description and the accompanying claims, the following terms shall have the meanings indicated, unless the context otherwise requires.

A “CMAC” is a Cipher-based Message Authentication Code as known in the encryption arts.

A “MAC” is a Message Authentication Code as known in the encryption arts. A CMAC is a type of MAC.

A “set” includes at least one member. Unless otherwise specified, a set may include as few as a single member, or may include a plurality of members.

As described herein, in illustrative embodiments a system or method designed for managing the ownership of an item or enabling functionality derived from such ownership begins its process by receiving a digital signature. This signature is produced by a signature generation device that is uniquely associated with the item in question. One noteworthy aspect of this initial step is the creation of the digital signature, serving as a distinct identifier for the item and ensuring that each interaction with the item can be securely recorded and authenticated.

Following the acquisition of the digital signature, the system then authenticates it. This authentication is carried out by an authentication device, specifically designed to verify the legitimacy of the digital signature received. The purpose of this phase is to ascertain that the digital signature indeed originates from the genuine signature generation device associated with the item, therefore confirming the item's identity and the validity of the interaction.

Upon successful authentication of the digital signature, the system initiates the transfer of ownership. This is achieved by allocating a digital token to a prescribed new owner. The digital token acts as a virtual representation of the item's ownership, encapsulating the rights and privileges associated with the item. The transfer of this token signifies the formal change in ownership, enabling the new owner to exercise their rights over the item.

The signature generation device's configuration preferably produces a unique digital signature for each scan or interaction. This means that the digital signature generated varies between at least two different instances of obtaining the signature from the device. Such a configuration ensures the security and integrity of the ownership management process, as it prevents the reuse or replication of digital signatures.

For example, the system could be designed so that the digital signature is incremented by one for each approved scan. This method of incrementing further enhances the security measures, ensuring that each transaction or interaction with the item is distinctly recorded and authenticated. This incremental approach not only facilitates the tracking of interactions, but also adds an additional layer of verification and trust to the entire process of managing ownership or enabling functionality based on ownership.

Among other options, the signature generation device can be equipped with Near Field Communication (NFC) technology. NFC allows for short-range communication between compatible devices by bringing them into close proximity, typically a few centimeters. This feature is helpful for the secure and efficient transmission of digital signatures directly from the physical item to the authentication device without the need for Internet connectivity, enhancing the system's versatility and user-friendliness in various operational environments.

In this context, the digital token, which signifies ownership, is carefully crafted as a blockchain element. This implies that the token is a distinct, immutable record on a blockchain, ensuring sufficiently high levels of security and transparency. By leveraging blockchain technology, the digital token benefits from decentralization, cryptographic security, and an auditable trail of ownership changes, which are benefits to blockchain's structure. This method of tokenization on the blockchain not only securely represents ownership rights, but also facilitates easy transfer and verification of these rights without the need for a central authority.

The digital signature itself may be generated through a variety of cryptographic methods, with one common approach involving the use of a private key stored securely within the signature generation device. This private key, part of a cryptographic key pair that includes a public key, is used to create a unique digital signature for each transaction or scan. The private key is never shared, ensuring that the digital signature can be verified by others using the corresponding public key, yet cannot be forged. This method essentially guarantees that each digital signature is both unique and securely tied to the item it represents, providing a robust authentication mechanism.

To acquire the digital signature from the signature generation device, illustrative embodiments scan in a conventional manner. This process typically involves the use of scanners or readers that are compatible with the technology used in the signature generation device, such as NFC readers for NFC-enabled devices. The act of scanning initiates a secure communication channel between the signature generation device and the scanner, facilitating the safe transmission of the digital signature. This scanning process is designed to be user-friendly and efficient, allowing for quick and easy authentication and ownership transfer operations without compromising security.

Each interaction with the signature generation device through scanning preferably is designed to be secure and precise, ensuring that the digital signature obtained is immediately ready for authentication and subsequent processes. This involves sophisticated protocols to manage the data exchange, including encryption and secure channels, to safeguard the integrity and confidentiality of the digital signature as it is transmitted from the signature generation device to the authentication system. Through these technical measures, the system ensures that the process of transferring ownership or enabling functionality associated with an item is both secure and user-friendly. Details of various embodiments are discussed below.

More specifically, encrypted NFC tags can be used to verify product authenticity and whether the user has possession of the physical item from the digital signature emitted by the tag upon reading the tag with a mobile phone or tag reader device. For example, NFC tags such as the NXP NTAG 424 DNA and NTAG ICODE DNA use symmetric key encryption for authenticity verification through a dynamic digital signature. Other known NFC tags that may be used in various embodiments include the Infineon NFC4TCxxx and the STMicro ST25TA-E.

The private encryption key needs to be used to authenticate and verify the signature. This means only the first party and trusted third parties can run the computation because the private key must be kept secure. This also increases the security requirements of the storage of the private key.

Each tag can be programmed with a private key. The private key cannot be read from the tag by design of the hardware. Write only, no read. The private key is used internally by the tag to compute the CMAC signature.
UUID—device identifier for the tag, usually guaranteed be unique
CTR—read counter, increments every time the tag is read—0001, 0002, 0003 . . .
CMAC—digital signature computed from the UUID, CTR, and the private key written into the tag using the algorithm that generates the CMAC. This signature changes with every read
Other data or parameters—some tags have special functionalities such as tamper detection and data payload storage.

The same encryption function that is used to calculate the signature may also used for verification. The only difference is from where the data is provided.

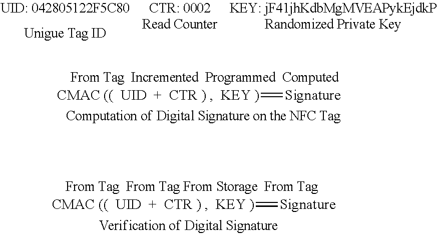

The signature can also be dependent on other tag parameters, such as tamper detection. If a tag is used to seal a container and the seal is broken, the NFC chip would detect the seal and an additional parameter would be added to the CMAC computation.

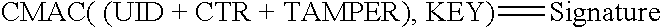

There are existing key management systems that manage the storage of the private key and the computation of the verification. Because the private key cannot be revealed, the verification needs to be securely performed by the key management systems. The database tables for such systems may look something like this.

### Tag Information:

| UID | Private Key | Other associated tag data |
|---|---|---|
| XXXXXXX | PPPPPPPPPPPP | Product info, etc. |

### Verification Information:

| UID | CTR | CMAC |
|---|---|---|
| XXXXXXX | 0001 | ABABABAB |
| XXXXXXX | 0002 | CDCDCDCD |

The verification service may do the following:
1. Calculate the CMAC signature against the counter and UID with the key for validity.
   a. If not valid, reject.
2. Check for existing verification entry for the same CMAC.
   a. If it exists, reject.
3. Check if the current counter is larger than any existing verifications in the database (optional depending on needs and situation).
   a. If it is less, reject.
4. Signature is valid and unused, save the current verification to the database to invalidate future use.
5. Accept as valid.

A limitation to these services is that the verification is not transparent and verifiable by a third party. The user must trust that the service is reputable and trustworthy. Because these third parties have to store the private key itself, there is a security risk of the key being compromised by hacks, accidental leaks, etc.

The inventors solved this problem. First, for signature verification. One embodiment will verify the CMAC computation without revealing the private key, a Merkle tree can store every possible combination of valid UID (unique tag ID), CTR (counter), and CMAC (encrypted signature) computed with the private key and hashed. A list of the possible combinations must be generated. For NTAG 424 DNA, the tag can be read up to 200,000 times so the CTR needs to be generated from 0-200,000, and can be less if the tags are expected to be read fewer times to save on computational and storage costs.

The size of the Merkle tree and the time it takes to generate it depends on the number of combinations of expected reads and the counters. Illustrative embodiments also generate a signature for each of the leaves of the Merkle tree. This obfuscates the input values. In some embodiments, however, this step for generating signatures could be skipped and each input value can be formatted so it is directly added to the Merkle tree as well for a less secure and less complex system. But for enhanced security, it is presented as a default step in this process.

Example may use the keccak256 cryptographic hash to compute the signature, but other algorithms may be used as well such as SHA256.
keccak256(0001,ABCD1234,A1B2C3)=>A2D3D3
keccak256(0002,ABCD1234,B2A1D3)=>872EAD
keccak256(0003,ABCD1234,A4B2E4)=>82ACFE

The list of signatures will be inserted into the Merkle tree. The insertion into the tree can happen during the generation of each signature, or afterwards when all signatures have been generated.

In adding a signature to the Merkle Tree, s\Some embodiments further transform each signature via a second hash to form a second tree leaf node hash:
Tree=new MerkleTree( )
tree.add(A2D3D3)=>B1C213
tree.add(872EAD)=>9D02A0
tree.add(A4B2E3)=>034DFC

In illustrative embodiments, this data may be the data associated with each verification combination. The signature is computed from the CTR, UID, and CMAC. The Tree leaf node is computed from the current leaf's signature and the signature from the chain of previous signatures. By definition, Merkle tree leave nodes are hashed recursively so the input of the previous builds is used to compute the next node as follows:
keccak256 (keccak256 (keccak256 (tag1), tag2), tag3)

| | | | | Second Tree leaf |
|---|---|---|---|---|
| CTR | UID | CMAC | Signature | node hash |
| 0001 | ABCD1234 | A1B2C3 | A2D3D3 | B1C213 |
| 0002 | ABCD1234 | B2A1D3 | 872EAD | 9D02A0 |
| 0003 | ABCD1234 | A4B2E3 | 82ACFE | 034DFC |

The root node that is connected to all other nodes via intermediate nodes can be used for verification of the existence of other nodes and their associated signature. Because the root node is smaller data size-wise than the entire Merkle tree, it can be shared and stored onto the blockchain and other mediums where memory space is very expensive or limited.

### Root Node

A92049

The entire Merkle tree can be stored as a list of leaf node hashes or other data structures and can be stored publicly and shared with others without leaking the protected data including the CMAC combinations. Only the hash itself needs to be shared, not any of the inputs. The Merkle tree can be quite large so it may be shared via other distributed file storage services such as Arweave, IPFS or via centralized storage such as AWS S3 or Google Cloud storage.

### Merkle Tree

B1C213;
9D02A0;
034DFC;

To verify, illustrative embodiments may load the Merkle tree and find the corresponding leaf node hash. The signature is computed from the inputs that need to be verified. The Merkle tree is then searched for the signature.
tree=MerkleTree.loadFromFile( )
signature=keccak256(0002,ABCD1234,B2A1D3)
tree.find(signature)

In some embodiments, the file containing the entire Merkle tree can be downloaded ahead of time, distributed via some offline means, such as CDs or USB drives, or installed as part of a larger prepackaged application. This facilitates use even when there is no network connectivity (e.g., no Internet connectivity).

If the tree cannot find the signature, then the combination of inputs does not exist and the verification failed. If the tree finds the signature, then the combination is valid. If there are additional parameters, these parameters can be added to the same tree if the result of the verification should remain the same.

In case of tamper, the input for the signature could be as follows:
tamper=CC if the seal is closed, tamper=OO if the seal is opened, or tamper=OC if opened and resealed and reset programmatically
tree.find(kecc256(0001,ABCD1234,A1B2C3,CC))=>true
tree.find(kecc256(0001,ABCD1234,A1B2C3,OO))=>false

Additional trees can be created for different sets of input parameters for the same tags as well. In this example, a new and different tree can be used to verify if the tag seal has been opened. A variation of the Merkle Tree called “Merkle Multi Signature” Tree can be used to verify conditions separately via different branches as well. A user or other person or artificial intelligence can download this Merkle tree and verify the digital signature from the NFC tag without security concerns around leaks of the private key, making the computation of the verification more widely accessible and self-verifiable.

To prevent reuse of old combinations, a list of previously used signatures can be stored. Before searching the Merkle Tree, the used list of signatures or Merkle leaf nodes can be searched to see if the signature has already been used. Similar to the verification entries from the cloud key management solutions.

| | | |
|---|---|---|
| Merkle tree leaf node | Signature | Time, User, other info |

| | |
|---|---|
| B1C213 | A2D3D3 |

The Merkle tree verification can be used in traditional servers, mobile devices, and other personal devices. The utility really shines on the blockchain and other trustless distributed systems because it reveals no private information while allowing all permitted sets of data to work. As known by those in the art, blockchain can be thought of as distributed computers running the same code and comparing with each other to reach consensus. Because storage and computation currently are expensive on the blockchain, data storage preferably should be minimized, and computing resources optimized as well. The Merkle root can be stored on the blockchain to verify the existence of the signature and the leaf node of the Merkle tree that is connected to the Merkle root as a subset of the Merkle root's dataset. A smart contract can be written to store the following set of data that can then be used to verify the signature from the tag and transact on the blockchain.

| | | | |
|---|---|---|---|
| UID | Root Node | Merkle Tree File | Other data related to |
| | | URL | the item including |
| | | | NFT, serial numbers, |
| | | | digital identifiers |
| ABCD1234 | A92049 | https://example.com/ | chainId: |
| | | tree.txt | contractAddress: |
| | | | tokenId: |

1. The client downloads the Merkle tree file,
2. Compute the signature for the set of inputs,
3. Find the Merkle node hash associated with the signature,
4. Submit the hash to the smart contract for programmatic validation,
5. The smart contract could then perform tasks or transactions that require authenticating the tag's signature or reject the task if validation did not pass.

The smart contract can also maintain a list of used signatures to invalidate used ones such that the same Merkle signature and hash cannot be used a second time.

As with other embodiments discussed above, in some embodiments, the file containing the entire Merkle tree can be downloaded ahead of time, distributed via some offline means, such as CDs or USB drives, or installed as part of a larger prepackaged application.

The different pieces of signature verification and invalidation can be performed on the blockchain or off chain on a device or a mix of different parts. The following can be performed with blockchain or normal devices, and each piece can be computed separately and interchangeably.
1. Compute Signature from inputs from the NFC tag,
2. Find invalidated signature,
3. Find Merkle leaf from signature,
4. Compute against Merkle root,
5. Store invalidated signature,
6. Perform authorized task after verification.

Other embodiments also related to conditionally transferable NFTS for digital twins of physical products with NFC tags.

Specifically, NFTs are often designed to be freely transferable and serve as digital collectibles. NFTs and related tooling in the blockchain ecosystem also provide a platform good for hosting multimedia such as images, videos, and related metadata. This same open platform can also be adapted to digital representations of physical products.

The concept of a digital twin, whether used as digital certificates of authenticity or ownership, or merely a digital collectible, is that both the digital and the physical should belong to the same owner as a combined product. The digital form as an NFT should not be freely resold and traded separately from the physical item.

Current NFTs typically are designed to be resold, although there are NFTs that cannot ever be transferred once created. Those are called “Soulbound NFTs”. One noteworthy type of digital twin NFT is selectively transferable upon a certain set of conditions and perhaps input from the physical product.

There are multiple types of NFTs and standards across many different ecosystems. In the Ethereum ecosystem, NFTs generally follow ERC721 or ERC1155. On Bitcoin, the standard is called Ordinals. There are many other standards for other chains.

The encrypted NFC tags, such as NXP DNA series or asymmetric ones, such as the HaLo NFC tags ones from ARX Research, can serve as verification inputs for toggling transferable states or enabling transfers. These transfers can be done on the blockchain with the above on-chain verification system or triggered by a centralized verification service such as the NXP cloud mentioned above. In the case of asymmetric tags, the public key can serve as the unique tag identifier and verified against the signature and a counter or other generated data, random and/or sequential. The private key does not need to be revealed.

Even static keys, such as a passcode from a scratch-off card, static NFC tag with a unique tag ID, QR code, serial number, or other identifiers, can be used as verification but with less degrees of security.

A few different mechanisms that could be used, including:
1. Allowing a certain number “verification free” transfers before requiring verification,
2. Allowing transfer only when there is verification,
3. Allowing transfer through an intermediate delegate such as third-party marketplace,
4. Restricting transfers to only certain allowlisted addresses, or blocking certain addresses.

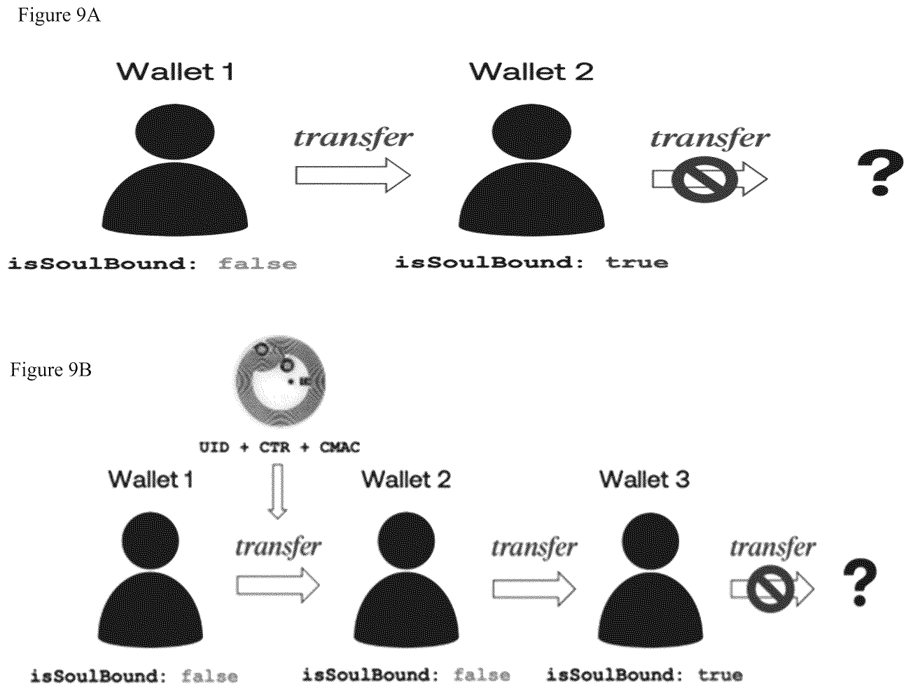

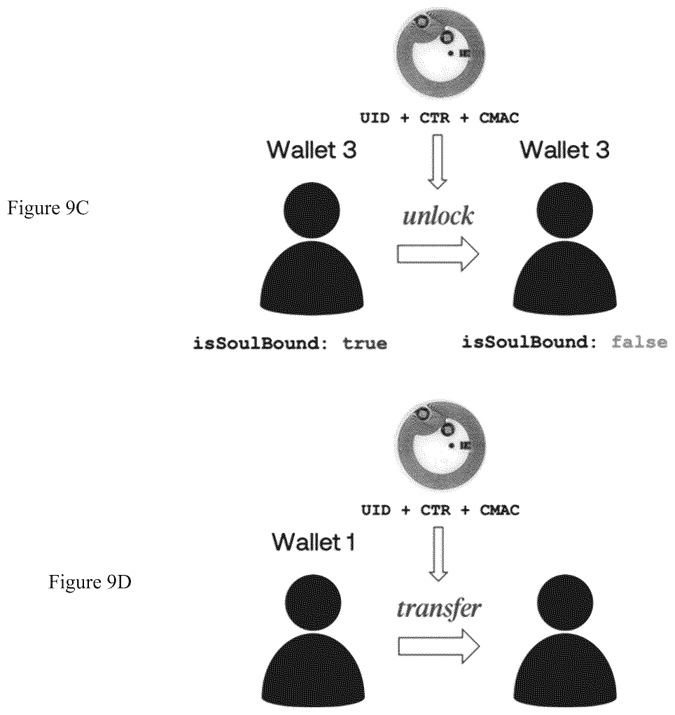

Some embodiments allow one transfer before the requiring verification from the tag. With reference to the FIG. 9A and FIG. 9B, wallet 1 transfers to wallet 2 without verification. Wallet 2 cannot transfer unless verified. The NFT would keep track of its own transferable state and also how many transfers there have been since the last verification (FIG. 9A).

If, however, wallet 1 transfers to wallet 2 with a verification, then wallet 2 can transfer to wallet 3, but wallet 3 cannot transfer (FIG. 9B).

Wallet 3 can either use the verification from the tag to transfer directly, or use the verification to unlock (FIG. 9C).

Some embodiments transfer only when there is verification. In illustrative embodiments, this model is simple. The NFT cannot be transferred unless it is verified (FIG. 9D).

Yet other embodiments allow transfer only through certain delegates or third parties. Specifically, this is an escrow model, such as real estate transfer. The title is transferred to the escrow company, and the escrow company verifies the conditions of the transfer, and then transfers the asset to the new owner. The NFT can have a list of allowed transfer addresses that are approved escrow or resale partners. The escrow partners also need to receive the physical item and verify with the tag before the NFT, and the physical item is transferred to the next owner.

This model may work for sneaker or luxury bag resale marketplaces, such as The Real Real or GOAT.com. The NFT is transferred to them, and they verify the shoes and the NFT, and send the item off to the buyer. They already currently do verification of the physical goods, this adds a digital component to it.

Still other embodiments allow transfers only between certain addresses or disallowing transfers to certain addresses. Specifically, for the goal of discouraging resale of the NFT without the physical item, a list of allowed addresses that are known customers can be used to receive the item without the tag verification. A similar list of disallowed addresses that are decentralized or NFT marketplaces can be used to ban the transfer of the NFT asset. If the asset has been transferred to any disallowed address, whether outside the allowlist or inside the ban list, the NFT would require verification from the tag in order to be transferred out of that banned address.

Indeed, those skilled in the art can combine any one or more of the above methods to achieve the specific transfer goals.

Illustrative embodiments involve product lifecycle and asset tracking with encrypted tags. Specifically, the inventors recognized that NFC and RFIDs without encryption can be scanned and the identifiers can be reused. If the identifiers are reused in tracking assets and their associated location or usages, then the resulting data can be falsified. In many use cases, such as supply chain and shipment tracking, that same identifier could be copied and resubmitted to fake shipments being sent past a checkpoint or delivery.

This also can apply to registration and deregistration of products and parts when entering or exiting their useful life cycle. A machinery part can be stolen and activated remotely if the tag ID can be copied. Similarly, an item that is supposed to be disposed of can be taken out and the tag identification copied and submitted remotely.

The inventors solved this problem. Specifically, using encrypted NFC tags, such as the NXP DNA symmetric encryption tag series or the ARX HaLo asymmetric tags and the above verification methods, illustrative embodiments can insert one or more additional layers of trust into each checkpoint or activation.

The tag's cryptographic signature can prevent the tag from being copied. Where additional security is necessary, the system can read the tag multiple times to get multiple signatures for stronger verification. Tags such as the NXP DNA series also support multiple encryption keys so the verification can check for the validity of multiple keys, making the verification even more difficult to fake. This is an existing functionality that is part of the NXP DNA series of tags. The data for this can be stored in a centralized server similar to the one NXP built for tag verification, and it can also be stored on a distributed system such as a blockchain.

Some embodiments ensure genuine human interactions with physical products through encrypted NFC tags. Specifically, for any digital goods of value that are given through in person and real-world events and campaigns, there are security and operational risks associated with using QR codes or other unencrypted links. An example of this would be a scavenger hunt. If people are directed to travel across a city to scan QR codes to confirm they have visited certain locations, those QR codes can be shared with other people through photos and accessed when someone is not at the physical location. A similar problem exists with unencrypted NFC Tags where the links from the tags are all the same and can be shared.

This would have monetary impact if the prizes or digital items collected from the QR codes have significant value, e.g., if the user scans all 10 QR codes across the city, they receive a free pair of shoes, or earn redeemable rewards points for each code scanned. The rewards can also be access to events or other forms of activations or other digital content such as music, videos, audiobook, etc.

There also are risks of hacking and fraud if the entire activation is verified digitally without human intervention. The inventors solved this problem. Specifically, using the encrypted tags, both asymmetric or symmetric encryption, and blockchain based verification or centralized verification servers, such as NXP cloud, illustrative embodiments authenticate whether the request came from the physical tag. If the event or activation is geofenced, it also ensures that the location of access is at the location of the physical tag.

The encryption reduces the tag sharing risk, but may not completely eliminate it because someone can read the generated single use link without opening it and send it to a friend. Illustrative embodiments mitigate this risk by reading multiple keys and signatures on the tag for enhanced security, such as the example given in product lifecycle tracking. Illustrative embodiments also can add time-based invalidation for previous links generated. Further embodiments can also use additional data from sensors on the reading device for verification as well.

Many of these encrypted NFC tags have read counters that are digitally signed with the encryption key; and preferably they are sequential, i.e., 0001, 0002, 0003, 0004, etc. The links are generated sequentially when read from the tag, but a user can also read the tag and not open it so it can be sent to someone else later.

To reduce the risk of generated links used later or by a third party, illustrative embodiments can invalidate previous links or introduce a time constraint.

If link with read counter 0005 is used, then 0004, 0003, 0002 are automatically invalid regardless of whether they have been used or not.

Time based Invalidation of Previous Links. If counter 0005 is accessed, some embodiments can allow 0004, 0003 and previous links must be used in a certain amount of time. This method can account for slower devices, unstable Internet, or people accessing the tag all at the same time and their phones work differently. Modest time frames, such as 30 to 60 seconds, can reduce the number of users who are not on-site with access to the tag from opening the link.

Some embodiments combine the signature from the tag with other data from the tag reading device to confirm if the user is a real human and if the user is at the location of the tag and has possession of the tag. To that end:
GPS to verify location,
Barometer, thermometer, altimeter, light sensor to verify weather and environment,.
Captcha verification and other anti-bot verification,
IP address, browser fingerprinting, cookies, and other semi-anonymous information.

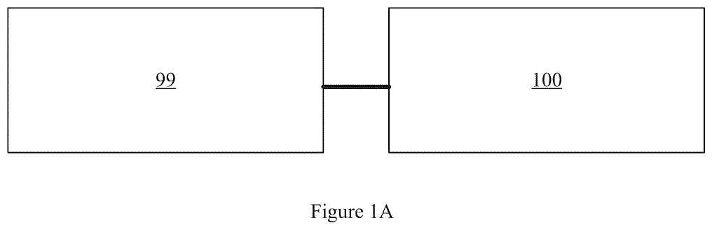

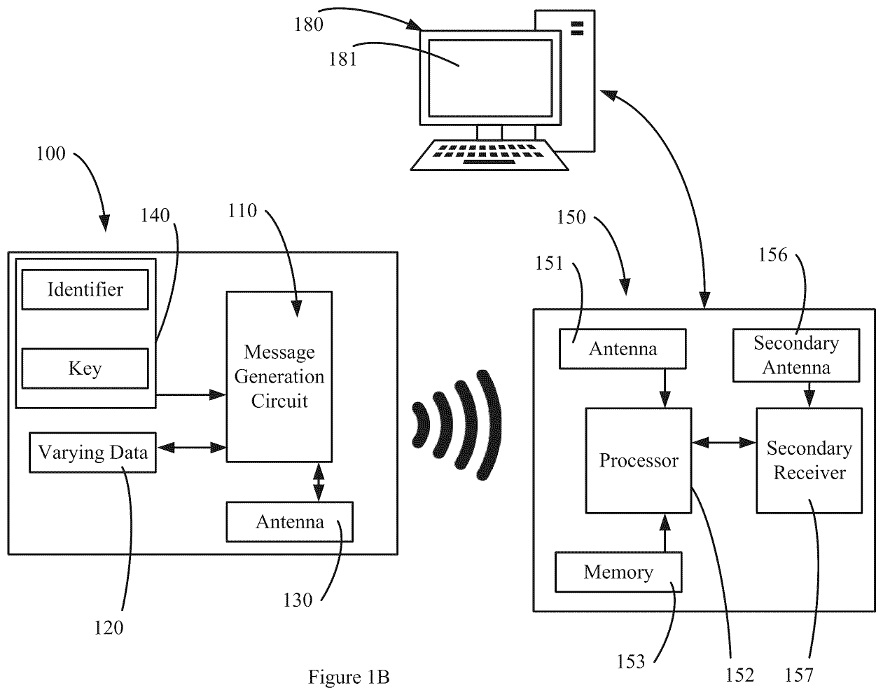

FIG. 1A schematically illustrates an object 99 coupled to a near-field communications (“NFC”) tag 100. In some embodiments, the object 99 is a physical (i.e., tangible) object and the NFC tag 100 is physically coupled to the object 99. In some embodiments, the object 99 is an intangible object (e.g., a non-fungible token; “NFT”) and the NFC tag 100 is virtually coupled to the object 99, for example by a record of an association between the NFC tag and the object in a memory or database.

FIG. 1B schematically illustrates a near-field communications tag 100 in wireless communication with a near-field communications reader 150. In some embodiments, the reader 150 may be in electronic communication with a computer 180 having a computer monitor 181. In some embodiments, the reader 150 may be in electronic communication with the computer 180 via a network, such has the Internet, or via another communication technology, such as wirelessly via Bluetooth, or via a wired connection such as an electrical cable. In some embodiments, the reader 150 may be configured to cause the computer 180 to display, on monitor 181, a digital experience in response to reading an NFC tag 100.

The NFC tag 100 has a set of memories 140 that store a unique identifier for (and specific to) the specific NFC tag 100 and an encryption key.

The NFC tag 100 also has a circuit (or “register”) 120 configured to generate variable data (which may also be referred-to as non-fixed data). For example, the stored variable data may be a counter that stores a variable number, and that increments that variable number each time the NFC tag 100 is read (i.e., the variable number is variable (or “non-fixed”) because it can be incremented).

In illustrative embodiments, the quantity of stored variable data is limited, for example to 100,000 or 200,000 unique items, and consequently that limits the number of unique authentication codes that can be generated from the unique identifier, the encryption key and the variable number.

The NFC tag 100 also has a message generation circuit 110 that creates a unique authentication code (e.g., a CMAC) from the unique identifier, the encryption key and the variable number.

Because the NFC tag 100 uses the variable number (along with the unique identifier and the encryption key) to create the authentication code, each authentication code produced by a specific NFC tag 100 is distinct and distinguishable from every other authentication code produced by that NFC tag 100 using those inputs.

The message generation circuit creates a message that includes the authentication code, the identifier, and the varying data used to create the authentication code.

The NFC tag 100 also has an antenna 130 configured to transmit the message.

Some embodiments include a system, for example as schematically illustrated in FIG. 1B. An illustrative embodiment includes a near-field communication (“NFC”) reader 150 having an antenna 151 (e.g., an NFC antenna) configured to receive a near-field communication signal, such as a message transmitted by an NFC tag 100 for example.

The reader 150 also includes a memory 153 storing a predetermined list of authentication codes. The predetermined list of authentication codes includes only codes that could be created by a specific NFC tag 100 using its corresponding unique identifier, the key, and a value from among the stored variable data. In illustrative embodiments, when the NFC tag 100 is fabricated, the predetermined list of authentication codes is generated using the identifier uniquely associated with the NFC tag 100, the key associated with the NFC tag 100, and a plurality of values of the variable data, and stored for use by a reader 150, and that predetermined list of authentication codes is stored in the memory 153.

In illustrative embodiments, the memory 153 stores the that predetermined list of authentication codes in a Merkle tree. The Merkle tree includes a plurality of leaves in which each leaf stores a signature comprising hashed data (each a signature, or hashed signature) from an NFC tag 100, each such hashed signature corresponding uniquely with a particular NFC tag in that each such hashed signature could only have been generated using a particular hashing algorithm and NFC tag data from a particular NFC tag 100. In illustrative embodiments, the NFC tag data includes (i) an NFC tag identifier (“UID”) uniquely corresponding to the particular NFC tag 100; (ii) an item of variable data generated by the particular NFC tag, the variable data having a value; and (iii) a CMAC generated from the NFC tag identifier and a value of the item of variable data and an encryption key.

The reader 150 also includes a processor 152 communicatively coupled to the antenna 151 and memory 153. The processor 152 is configured to authenticate a message without decrypting the message (or the authentication code within the message). In illustrative embodiments, the reader 150 does not even have a copy of, or access to, a key with which it could decrypt the message or the authentication code. In illustrative embodiments, the computer processor 153 is configured, by virtue of software configured to executed by the computer processor 153, to authenticate a first message in question received by the NFC reader 150 as being from a particular NFC tag 100, which particular NFC tag 100 is uniquely associated with a particular corresponding physical item 99. In illustrative embodiments, the computer processor 152 is configured to authenticate a first message in question by: extracting, from the first message in question, a first plurality of individual data items, said individual data items being first extracted data items; hashing the first extracted data items with the particular hashing algorithm to form a first signature in question; and determining that the signature in question is on a leaf of said Merkle tree.

In some embodiments, the computer processor 152 is configured to authenticate a second message in question as being from the same particular NFC tag 100, which second message in question is received by the reader 150 subsequent to the first message in question, and the second message in question not identical to the first message in question.

Some embodiments of the reader 150 include one or more a secondary antennas 156 and one or more secondary receivers in communication with a one of the secondary antennas.

In some embodiments, the secondary antenna 156 is a GPS antenna configured to receive GPS signals, and the secondary receiver 157 is a GPS receiver configured to receive GPS signals from the GPS antenna and to determine the geographic location of the reader 150, and thereby the geographic location of the particular NFC tag 100 from the global positioning system data. The GPS receiver 157 is in data communication with the processor 152. In illustrative embodiments, the GPS antenna 156 is distinct from the NFC antenna 151.

In some embodiments, the secondary antenna 156 is a cellular antenna configured to receive cellular radiofrequency signals from one or more cellular network antennas and the secondary receiver 157 is configured to process such cellular signals to triangulate, from known locations of the one or more cellular network antennas, the location of the reader 150 at the time of receipt of such cellular signals.

In some embodiments, the secondary antenna 156 is a wifi antenna configured to receive wifi radiofrequency signals from one or more wifi routers and the secondary receiver 157 is configured to process such wifi signals to determine the location of the reader 150 at the time of receipt of such wifi signals.

In some embodiments, the first plurality of individual data items includes a first item of variable data generated by the particular NFC tag; and the second message in question includes a second plurality of individual data items, which second plurality of individual data items includes a second item of variable data generated by the particular NFC tag, the second item of variable data having a value that is incremented from the first item of variable data from the first message in question.

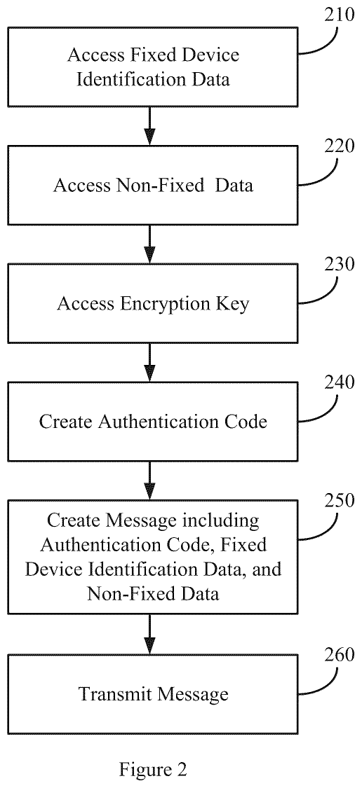

FIG. 2 is a flowchart illustrating a method used by a tag 100 to create a message.

At step 210, the message generation circuit 110 accesses (e.g., obtains a copy of) the identifier.

At step 220, the message generation circuit 110 accesses (e.g., obtains a copy of) the value of the variable data, which value is the value of said data at the time of access.

At step 230, the message generation circuit 110 accesses (e.g., obtains a copy of) the encryption key.

At step 240, the message generation circuit 110 generates a unique authentication code using the identifier, the value of the variable data, and the encryption key.

At step 250, the message generation circuit 110 generates a unique message, the message including the identifier, the value of the variable data, and the authentication code.

At step 260, the NFC tag 100 transmits the message. In illustrative embodiments, the NFC tag 100 transmits the message subsequent to, and in response to, receipt by the NFC tag 100 of a query from an external device, such as reader 150 for example.

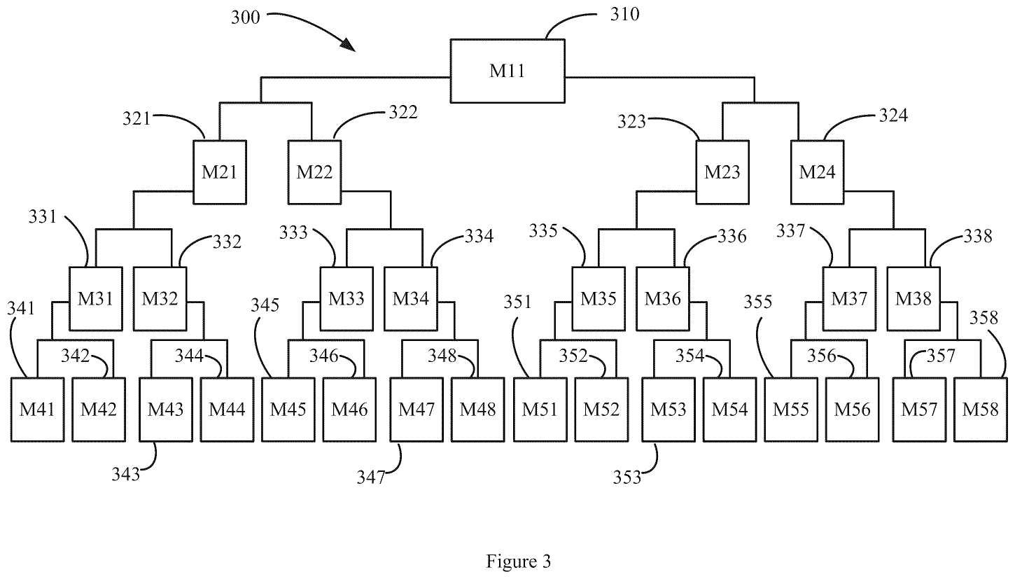

FIG. 3 schematically illustrates an embodiment of a Merkle tree 300. The Merkle tree 300 has a root node 310, and a plurality of “leaf” nodes (collectively, “leaves”) 341, 342, 344, 345, 346, 347, 348, 351, 352, 353, 354, 355, 356, 357 and 358. The Merkle tree also has a plurality of intermediate nodes.

Intermediate nodes 331, 332, 333, 334, 335, 336, 337 and 338 are one level above the level of the leaf nodes. The value of an intermediate node is a hash of the value of its two associated nodes on a level below the intermediate node.

For example, leaf node 341 is a sibling of leaf node 342 because the hash of the value of node 341 (represented in FIG. 3 as “M41”) with the value of node 342 (represented in FIG. 3 as “M42”) is the value of intermediate node 331 (represented in FIG. 3 as “M31”) in the layer immediately above. Similarly, leaf node 343 is a sibling of leaf node 344 because the hash of the value of leaf node 343 (represented in FIG. 3 as “M43”) with the value of leave node 344 (represented in FIG. 3 as “M44”) is the value of intermediate node 332 (represented in FIG. 3 as “M32”) in the layer immediately above.

The value of node 321 (represented in FIG. 3 as “M21”) is the hash of the value of node 331 (represented in FIG. 3 as “M31”) with the value of its sibling node 332 (represented in FIG. 3 as “M32”).

The value of the root node 311 (represented in FIG. 3 as “M11”) is the hash of the value of node 321 (represented in FIG. 3 as “M21”) with the value of its sibling node 322 (represented in FIG. 3 as “M22”).

A Merkle tree 300 can act as (and be used as) a simple data repository in which each leaf stores an associated data item. For example, the data items stored in the leaf nodes may be part of a dataset. If a user has a data item, and wants to confirm that the data item is a part of the dataset, the user can merely search the leaves to determine whether that data item is in one of the leaf nodes. If that data item is in one of the leaf nodes, then that data item is part of the dataset, and otherwise that data item is not part of the dataset. Such an approach, however, requires that the user has access to all of the leaves. That may be undesirable where there are many leaves that collectively occupy a relatively large memory.

A Merkle tree, however, can enable a user to determine whether a data item is part of the dataset (i.e., perform a data verification function) even if the user does not have, or does not have access to, all of the leaves.

For example, with reference to FIG. 3, if a user has a data item (or “item of interest”) that the user suspect might be the data (M46) in in leaf 346, the user can confirm whether that item of interest is part of the dataset by hashing that item of interest with the known data in leaf 345 (M45), to form the data of intermediate node 333. The user can then hash the data thus calculated for intermediate node 333 with the known data of intermediate node 334 (M34) to calculate the data of intermediate node 322. The user can then mesh the data thus calculated for intermediate node 322 with the known data of intermediate node 321 (M21) to form the data for the root node 310. If the data thus calculated for the root node 310 matches the data stored in the root node 310 (M11), then the item of interest is a part of the dataset (i.e., the item of interest matches M46). On the other hand, if the data thus calculated for the root node 310 does not match the data stored in the root node 310 (M11), then the item of interest is not part of the dataset (i.e., the item of interest does not match M46). As illustrated by the foregoing example, the user can determine whether the item of interest is part of the dataset by having only one other leaf node and a subset of the intermediate nodes of the Merkle tree 300—i.e., the data from sibling leaf node 345, and the data of intermediate node 334 (M34) and intermediate nod 321 (M21), and the data of the rood node (M11).

In some embodiments, rather than store data that is part of a dataset, each leaf holds a hashed value of a corresponding item of data from the dataset. In that way, if an unauthorized or untrustworthy party obtains a copy of the leaves, that party does not obtain data from the dataset. The Merkle tree 300, as described above, can still perform its verification function, however, by performing the hashing operations described above on the (hashed) data in the leaves.

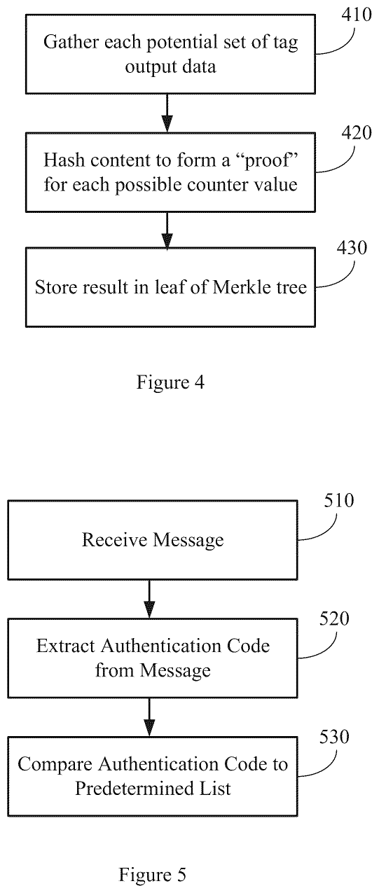

FIG. 4 is a flowchart of an embodiment of a method of forming a Merkle tree corresponding to a particular near field communication tag. In illustrative embodiments, each particular NFC tag includes an NFC tag identifier (“UID”) uniquely corresponding to the particular NFC tag, and is configured to generate (e.g., using generator 120) an item of variable data, the variable data having a value; and is configured to generate a CMAC from the NFC tag identifier and a value of the item of variable data and an encryption key. In illustrative embodiments, the generator 120 is a counter configured to increment the value of variable data each time the NFC tag is read by an external reader.

Step 410 includes gathering each potential set of NFC tag output data. Each such set includes the UID, a value of the variable data, and the CMAC generated from the IDS and value of the variable data. Because the variable data can take a plurality of values, including a unique value for each time the NFC tag is read by a reader, each potential set of NFC tag output data is unique. For example, in embodiments in which the generator 120 is a counter, each potential set of NFC tag output data is unique because each set of NFC tag output data has a corresponding unique counter value.

Step 420 includes hashing each potential set of NFC tag output data using a first corresponding specified hash function, to form a unique signature corresponding to each potential set of NFC tag output data. Some embodiments transform each such unique signature by a second function, which second function may include, for example, a second specified hash function. In some embodiments, the second specified hash function is a different hash function from the first corresponding specified hash function. In some embodiments, the second specified hash function is the same as the first corresponding specified hash function.

Step 430 includes storing each unique signature on a corresponding unique leaf of a Merkle tree. In illustrative embodiments, each unique leaf may uniquely correspond to a unique item of variable data of the NFC tag. For example, in embodiments in which the generator 120 is a counter, each leaf may be uniquely associated with a counter value. For example, in one illustrative embodiment, leaf 0001 (341 in FIG. 3) corresponds to counter value 0001, and leaf 0002 (342 in FIG. 3) corresponds to counter value 0002, and leaf 0003 (343 in FIG. 3) corresponds to counter value 0003, and so forth.

FIG. 5 is a flowchart illustrating an embodiment of method of authenticating an encrypted message at a reader. In preferred embodiments, the reader 150 is configured to authenticate the message, even though the reader 150 does not have, and does not have access to, the encryption key that was used to create the message. Illustrative embodiments are configured to authenticate the message without decrypting the message, or any portion of the message, and illustrative embodiments authenticate the message without decrypting the message, or any portion of the message. In illustrative embodiments, a reader 150 is configured to authenticate the message without communicating with an external computer, for example without communicating with an external computer using an application program interface. In illustrative embodiments, a reader 150 is configured to authenticate the message using only recourses available on (i.e., as part of) the reader 150 itself.

At step 510, the reader receives the message. In illustrative embodiments, the reader 150 receives the message from the NFC tag 100 that generated the message. In illustrative embodiments, the reader 150 receives the message less than one second after the message was generated. In illustrative embodiments, prior to receiving the message, the reader 150 sends a request to the NFC tag 100, pursuant to which the NFC tag generates and sends the message.

At step 520, the reader (e.g., the processor) reads the authentication code from the message. The authentication code as read may be referred-to as an extracted authentication code.

At step 530, the reader 150 authenticates the message using the extracted authentication code. In illustrative embodiments, the reader 150 authenticates the message by confirming that the extracted authentication code is on a predetermined list of authentication codes, which predetermined list of authentication codes corresponds uniquely to a specific NFC tag 100. Illustrative embodiments determine whether the extracted authentication code is on the predetermined list, and take one of two actions: if the authentication code is on the predetermined list the message is authenticated, and if the authentication code is not on the predetermined list authentication is denied.

In some embodiments, the predetermined list of a plurality of authentication codes includes a plurality of hashed authentication codes in an organized data structure, which could include, for example, a database, a list, and a spreadsheet, to name but a few examples.

In illustrative embodiments, the predetermined list of authentication codes includes a Merkle tree in which each leaf represents a corresponding authentication code that could be generated by a specific NFC tag 100. Such a Merkle tree allows non-trusted entity (e.g., reader 150) to authenticate the output of the tag 100. In some embodiments, the Merkle tree does not include all possible authentication codes, but instead includes only a subset all possible authentication codes, to mitigate the risk of possible reverse engineering by a third party in possession of the Merkle tree.

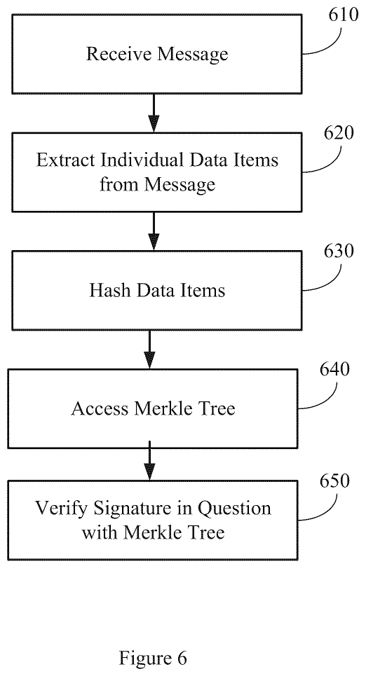

FIG. 6 is a flowchart illustrating an embodiment of method of authenticating an encrypted message at a reader 150, which encrypted message is (at least ostensibly) from an NFC tag associated with a physical object. In some embodiments, the particular NFC tag is physically coupled to the particular corresponding physical item.

Step 610 includes receiving, at a first time and directly at a reader 150 via near-field communication, a first message in question, the message in question comprising a first plurality of individual data items.

Step 620 includes extracting, by the reader 150 from the first message in question, the first plurality of individual data items, said individual data items being first extracted data items.

Step 630 includes hashing the first extracted data items with a particular hashing algorithm to form a first signature in question.

The method also includes authenticating, by the reader 150 and on the reader 150, that the first message in question is from a particular NFC tag, which particular NFC tag is uniquely associated with a particular corresponding physical item.

To that end, Step 640 includes accessing a Merkle tree stored in memory of the reader 150, the Merkle tree comprising a plurality of leaves in which each leaf stores a hashed signature, each such hashed signature corresponding uniquely with the particular NFC tag 100 in that each such hashed signature could only have been generated using the particular hashing algorithm and NFC tag data from the particular NFC tag 100. In illustrative embodiments, the NFC tag data includes: (i) an NFC tag identifier (“UID”) uniquely corresponding to the particular NFC tag; (ii) an item of variable data generated by the particular NFC tag 100, the variable data having a value; and (iii) a CMAC generated from the NFC tag identifier and a value of the item of variable data and an encryption key.

In illustrative embodiments, the value of item of variable data generated by the particular NFC tag 100 comprises a discrete number selected from a set of discrete numbers between zero and 1,000,000.

In some embodiments, the particular NFC tag 100 includes a digital counter (120) configured to produce an output value and to increment that output value each time the NFC tag 100 is read, which output value comprises the item of variable data.

Step 650 includes verifying the signature in question using the Merkle tree. In illustrative embodiments, Step 650 includes determining that the signature in question is on a leaf of said Merkle tree.

Some embodiments include Step 660 subsequent to authenticating (by the reader 150 and on the reader 150) that the first message in question is from a particular NFC tag, which particular NFC tag is uniquely associated with a particular corresponding physical item 99.

For example, in some embodiments, Step 660 includes, subsequent to and consequent to authenticating that the first message in question is from the particular NFC tag, recording on a ledger a transfer of ownership of the particular corresponding physical item 99 to the holder of the particular NFC tag.

In some embodiments, the holder of both the particular NFC tag and the particular corresponding physical item 99 is an escrow agent, which escrow agent has graded the condition of the particular corresponding physical item 99. In some such embodiments, Step 660 further includes, subsequent to authenticating that the message in question is from the particular NFC tag, recording of a transfer of ownership of the particular corresponding physical item 99 to the escrow agent; and transferring both the particular NFC tag and the particular corresponding physical item 99 to purchaser of the particular corresponding physical item 99.

In some embodiments, Step 660 includes, subsequent to authenticating that the first message in question is from the particular NFC tag, denying a recording of a transfer of ownership of the particular corresponding physical item 99 to the holder of the particular NFC tag.

In some embodiments, Step 660 includes, subsequent to authenticating that the first message in question is from the particular NFC tag, permitting a recording of a transfer of ownership of the particular corresponding physical item 99 to the holder of the particular NFC tag only if the holder of the particular NFC tag is a pre-approved recipient of the particular corresponding physical item 99.

Some embodiments include receiving, directly at the reader via near-field communication, a second message in question comprising a second plurality of individual data items; and authenticating, by the reader 150 and on the reader 150, that the second message in question is from the particular NFC tag.

In some embodiments, receiving, directly at the reader via near-field communication, the message in question occurs at a first time, and authenticating, by the reader 150 and on the reader 150, that the message in question is from the particular NFC tag must occur prior to a pre-determined second time, said pre-determined second time subsequent to and measured from the first time.

In some embodiments, the first plurality of individual data items includes global positioning system data reporting a geographic location of the particular NFC tag at the first time, and the reader comprises a GPS receiver configured to determine the geographic location of the particular NFC tag, at the first time, from the global positioning system data.

In illustrative embodiments, authenticating that the first message in question is from the particular NFC tag is performed without use of the encryption key.

In illustrative embodiments, authenticating that the first message in question is from the particular NFC tag is performed without decrypting any of the NFC tag data.

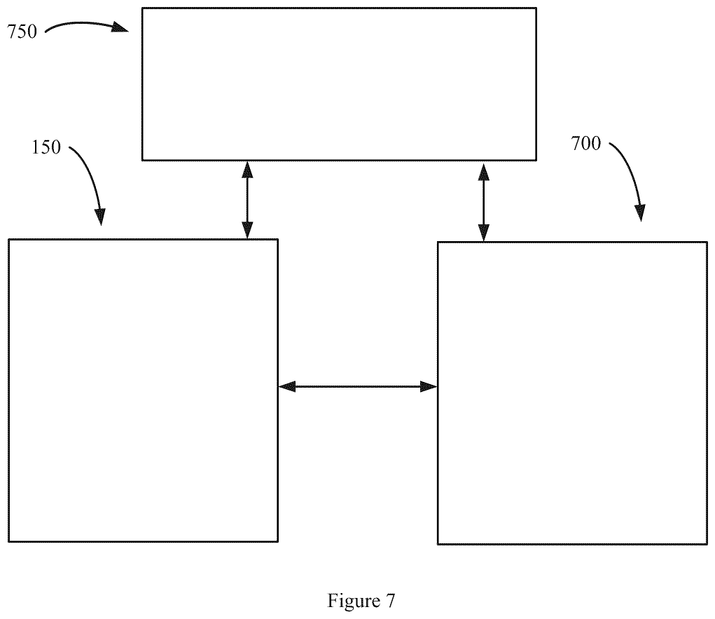

Some embodiments also verify that the authentication code has not been used previously to validate a message. To that end, FIG. 7 schematically illustrates a reader 150 in communication with a blockchain processor 700.

For example, an operator may be concerned that a third party may have intercepted a message at a previous time, and presented a copy of the intercepted message to the reader 150. Consequently, some embodiments pass the extracted authentication code to a blockchain processor 700. The blockchain processor 700 determines whether the extracted authentication code is included in a blockchain corresponding to the specified NFC tag 100. If the extracted authentication code is not included in the blockchain, then the blockchain processor 700 confirms to the reader 150 that the authentication code has not been used previously; and otherwise (if the extracted authentication code is not included in the blockchain) then the blockchain processor 700 alerts the reader 150 that the authentication code has been used previously.

One purpose of the use of the blockchain is to enable sellers to provide users with incentives or rewards for performing the action of authenticating the NFC message.

For example, a user may purchase a product bearing and NFC tag, and the seller of the product may provide a reward to the user upon the user reading the NFC tag and authenticating the message from the NFC tag. For example, the seller may send to the user a digital coupon in the form of an electronic message, or a token that the user may exchange for an electronic prize (for example, a non-fungible token) or physical prize.

In some embodiments, the reward may include one or more of the following:
NFTs (digital collectibles)
tokens and cryptocurrency
digital content such as music, movies, etc.
discount codes or digital coupons that are redeemable for something else, digital or physical
tickets and access—receiving a digital ticket to an in-person or access to a virtual event or community
in-game content—digital items, characters, upgrades, or downloadable content within a game or other metaverse virtual experiences

To that end, some embodiments provide a reward contingent on the user authenticating a message from more than one NFC tag. For example, a source of a product may make such a reward contingent on the user acquiring more than one product from the source and reading an NFC tag associated with each such product (e.g., user must acquire one unit of each color of a product that comes in a plurality of colors). As an other product, a source may make such a reward contingent on a user finding all elements of a scavenger hunt, and reading an NFC tag associated with each such.

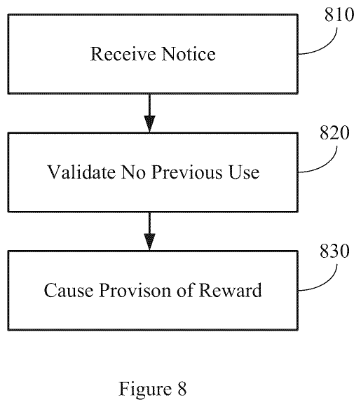

FIG. 8 is a flowchart illustrating an embodiment of method of providing a reward to a user.

Step 810 includes receiving, at a computer system 750 from the NFC tag reader 150, notice that the NFC tag 150 reader has authenticated a first message from a first NFC tag, said first message being an authenticated message having an associated first authentication code. The computer system 750 and blockchain processor 700 may be part of a single system, or independent of one another.

Step 820 includes validating, by the computer system 750, that the associated first authentication code has not been used previously to authenticate a message from said first NFC tag, said validation be a first validation. In illustrative embodiments, the computer system 750 performs said validating in consultation with blockchain processor 700.

Step 830 includes, in response to and contingent on said first validation, causing a reward to be provided to the party that used the NFC reader to read the message from the first NFC tag.

In some embodiments, the first NFC tag is associated with a product from a product source; and causing a reward to be provided to the party using the NFC reader comprises causing said reward to be provided to the party from the product source.

Some embodiments make a reward contingent on a user authenticating a plurality of messages from a corresponding plurality of NFC tags.

For example, one embodiment step 810 includes receiving, at the computer system from the NFC tag reader, notice that the NFC tag reader has authenticated a second message from a second NFC tag, said second message being a second authenticated message having an associated second authentication code. Said embodiment further includes, at step 820, validating, by the computer system, that the associated second authentication code has not been used previously to authenticate a message from said second NFC tag, said validation being a second validation. In such an embodiment, causing a reward to be provided to the party that used the NFC reader (step 830) is further contingent on said second validation.

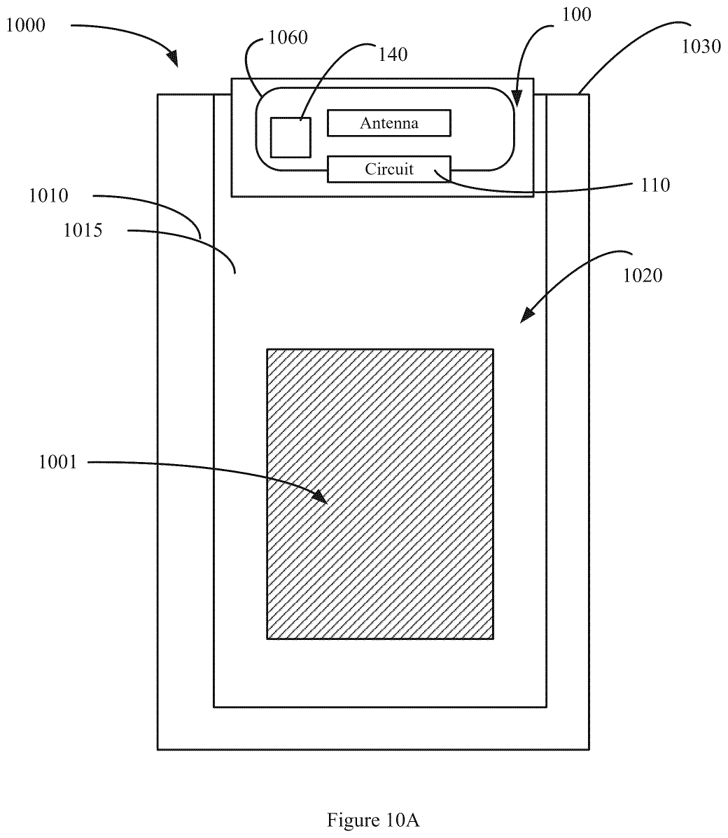

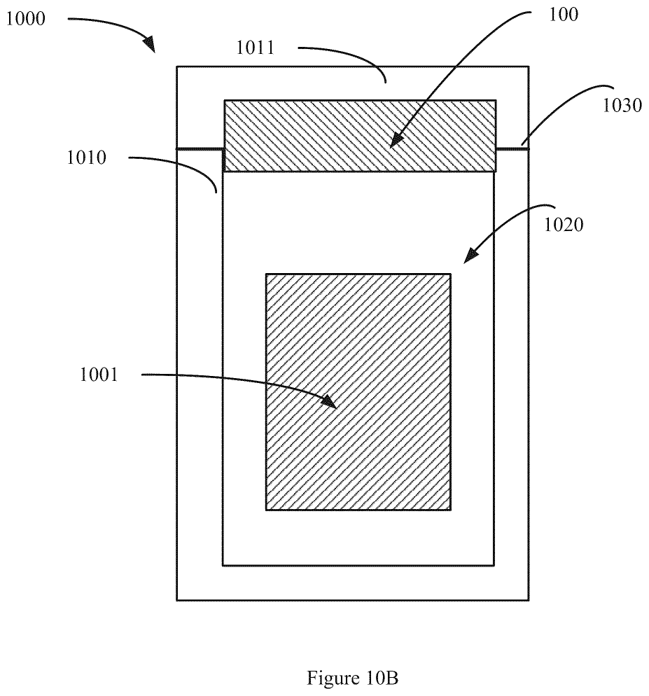

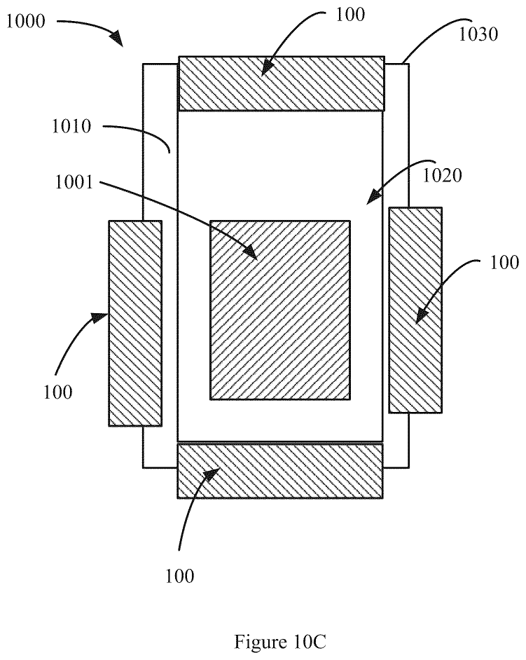

FIG. 10A schematically illustrates an embodiment of a tamper-resistant (or tamper-detecting) container 1000. The container 1000 includes a case 1010 having a closeable pouch 1015 defining an interior volume 1020. The interior volume 1020 is configured to hold a physical object (or “item”) 1001. In illustrative embodiments, the case 1010 includes a cavity that has an opening 1030, which cavity and opening 1030 define the interior volume 1020. In some embodiments, the case 1010 includes a flap or cap 1011 to close or fold over the opening 1030 of the cavity. In illustrative embodiments, the physical object is a collectible item 1001. The collectable item 1001 is illustrated in the figures is not part of the tamper-resistant container 1000.

The interior volume 1020 can be closed, for example by folding the flap or cap 1011 over the opening 1030, to prevent removal of a collectable item 1001 inside the interior volume 1020. In illustrative embodiments, the tag 100 is disposed across the opening 1030, to span the opening such that opening the pouch at the opening disturbs the tag 100 to make the tag 100 change state. In this way, the interior volume 1020 may be sealed from the environment outside the container 1000.

The case 1010 includes an opening, or aperture, 1030 to enable an object item 1001 to be inserted into the interior volume 1020, and/or removed from the interior volume 1020. In some embodiments, the opening 1030 is an edge of the case 1010, which edge has not been closed. In some embodiments, the case 1010 may have a flap 1011 configured to fold over the opening 1030.

The tamper-resistant container 1000 also includes a tamper-detecting near field communications (“NFC”) tag 100 secured to the case 1010 and configured to change a state in response to an opening of the case 1010 after the NFC 100 tag has been applied. In illustrative embodiments, the NFC tag 100 is configured to transmit information indicating the change of state. In illustrative embodiments, the change of state of the tag includes a change in information transmitted by the tag in response to an inquiry from an NFC reader.

An embodiment of such an NFC tag 100 is schematically illustrated in FIG. 10A, and includes a wire 1060. The NFC tag 100 is disposed on the case 1010 in a position such that opening the case 1010 causes the wire 1060 to be broken. To that end, in illustrative embodiments, the NFC tag 100 is disposed to cover, or pass over, the opening 1030. In illustrative embodiments, the wire 1060 is in addition to the antenna 130, so that the antenna 130 remains functional after the wire is broken.

FIG. 10B schematically illustrates an embodiment of such an NFC tag 100 over an opening 1030 in a case 1010 that has a flap 1011 covering the opening 1030.

The circuit 110 is configured to detect that the wire 1060 is broken. For example, the circuit 110 may impose a voltage or a current on the wire 1060 at one node where the wire is coupled to the circuit, and determine that the wire 1060 is intact if the circuit 110 can detect that voltage or current at the other node where the wire 1060 is coupled to the circuit 110. In illustrative embodiments, circuit 110 also includes a transmitter configured to transmit information (which may be referred-to as transmission information, which is a type of output data) in response to an inquiry from an NFC reader.

In some embodiments, the transmission information describes a first state of the tag 100 when the wire 1060 is intact, and a second state different and distinguishable from the first state when the wire 1060 is not intact. In such embodiments, a reader 150 (or other circuit in communication with the reader 150) may determine the state of the tag 100 (i.e., first state or second state), and/or that the tag 100 has changed state. For example, in some embodiments, such a reader may determine that the tag 100 has not changed state when the information indicates that the tag 100 is in the first state (e.g., wire 1060 is intact), and may determine that the tag 100 has changed state (e.g., the wire 1060 is not intact) if the transmission information indicates that the tag 100 is in the second state.

In some embodiments, the circuit 110 may be configured to store an item of data (for example, in a latch or register) that describes whether the state of the tag 100 has changed from the first state to the second state. That item of data may be referred-to as state-change data. The circuit 110 may be configured to transmit that item of data as transmission information, such that a reader 150 (or other circuit in communication with the reader 150) may determine from that state-change data that the tag 100 has changed state.

In some embodiments, the NFC tag 100 includes a wire 1060 that is long enough to be disposed near more than one edge or seam of the case 1010. In some embodiments, the NFC tag 100 includes several wires 1060 so that each wire can be disposed near a corresponding edge or seam of the case 1010, wherein each wire 1060 is in addition to the antenna, so that the antenna remains functional after the wire is broken.

Some embodiments contain a set including more than one (e.g., two or more) NFC tags 100. For example, FIG. 10C schematically illustrates a container 1000 having a case with an opening 1030 and a plurality of edges, where the opening 1030 and each edge is spanned by an NFC tag 100.

In some embodiments, the case 1010 has a separate (second) pouch (or “tag-holding pouch”) or pocket in addition to the pouch that holds the item, which second pouch is configured for holding the NFC tag within the case 1010.

In some embodiments, the NFC tag 100 is disposed within the closeable interior pouch (i.e., in interior volume 1020) along with the collectable item 1001.

In some embodiments, the NFC tag 100 is configured to encrypt information that it sends in response to an inquiry from a reader.

In some embodiments, the NFC tag 100 is configured to encrypt such data using symmetric encryption and so is configured to transmit symmetrically encrypted information (which may be referred-to as the “output” of the NFC tag 100) indicating the change of state.

In some embodiments, the NFC tag is configured to encrypt data using asymmetric encryption and so is configured to transmit asymmetrically encrypted information (which may be referred-to as the “output” of the NFC tag 100) indicating the change of state. For example, for asymmetric encryption, the NFC tag 100 uses a public key and a corresponding private key (which collectively may be referred-to as an “asymmetric key pair”). In illustrative embodiments, a public key and a private key of an asymmetric key pair are generated at the same time, either during manufacturing of the NFC tag 100, or programmed into the NFC tag 100 afterwards.

A receiver of asymmetrically encrypted information transmitted by such an NFC tag 100 could authenticate the transmission (output) from the tag 100. Authenticating such an output would merely compute a public key string to verify the output from the tag

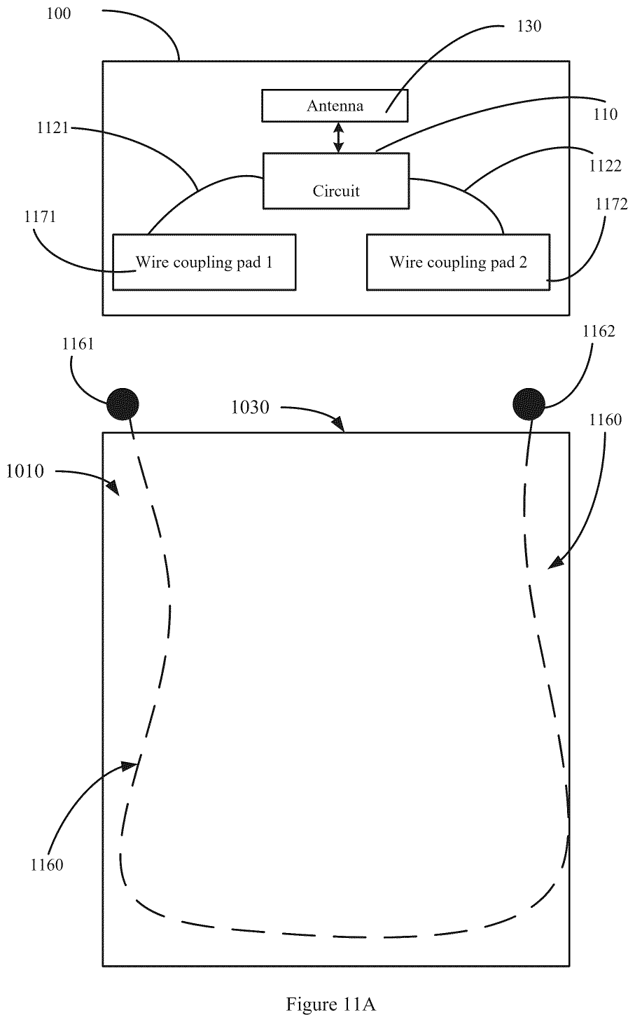

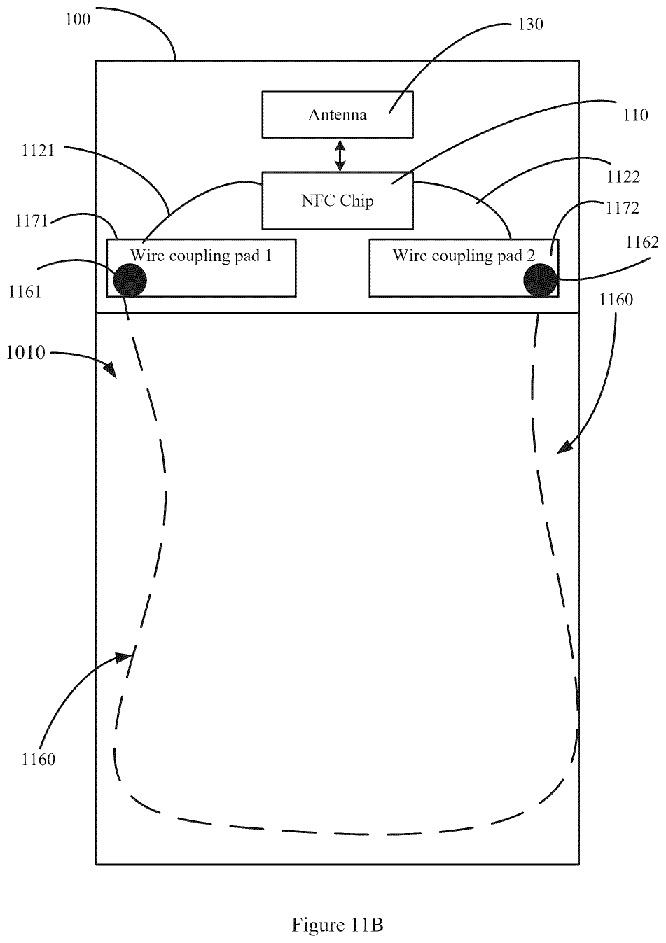

FIG. 11A and FIG. 11B schematically illustrate an embodiment of a tamper-resistant container 1000. In FIG. 11A, the case 1010 includes a wire 1160, which wire has a first wire end 1161 and a second wire end 1162. In illustrative embodiments, the wire 1160 is disposed along an edge or seam of the container 1010, so that an opening of such edge or seam will break the wire 1160.

The first end 1161 of the wire is configured to electrically couple to a first bonding pad 1171 of NFC tag 100, and the second end 1162 is configured to electrically couple to a second bonding pad 1172 of NFC tag 100. To that end, in some embodiments each wire end 1161, 1162 may have a corresponding end bond pad (1171 and 1172, respectively). Bonding pad 1171 is coupled to circuit 110 by conductor 1121, and bonding pad 1172 is coupled to circuit 110 by conductor 1122 so that circuit 110 can detect a break in the wire 1160, and/or a break in conductor 1121, and/or a break in conductor 1122.

FIG. 11B schematically illustrates the first end 1161 of the wire electrically coupled to first bonding pad 1171 of NFC tag 100, and the second end 1162 electrically coupled to a second bonding pad 1172 of NFC tag 100. Such electrical couplings may include galvanic couplings. When connected in this way, the wire 1060 may be considered to be part of the tag 100, and breaking the wire 1060 cause a change of state of the tag 100.

When the NFC tag 100 is coupled to the case to cover to the closeable opening 1030 as shown in FIG. 11B, a subsequent opening of the closeable opening 1030 causes a change in state of the response of the NFC tag 100.

An advantage of the embodiment of FIG. 11A and FIG. 11B is that it allows protection of one opening or edge of the case 1010, or more than one opening or edge of the case 1010, without requiring a user to precisely position the wire 1160 on or in the case 1010. Furthermore, such embodiments allow the NFC tag to be simpler, and less fragile, because such an NFC tag 100 does not need to include a wire (e.g., wire 1160 of FIG. 10A, for example) because the wire 1160 is provided by the case 1010.

In some embodiments, scanning the NFC tag 100 by an NFC reader 150 causes opening of a digital experience (e.g., on a display 181 of a computer 180, for example via a web page) that displays contents about the history of the content 1001 of the container 1000. To that end, in some embodiments the first tamper-detecting NFC tag 100 is configured to cause a reader 150 to cause display, on a computer screen 181 in response to being read by the reader 150, of the digital experience. A digital experience could include, without limitation, one or more of text, a set of videos, a set of images, audio content, virtual reality content; augmented reality content; a set of games, a set of signup or raffle forms, and a set of digital event tickets, to name but a few examples.

To that end, in some embodiments, the NFC tag 100 includes a memory 140 holding digital information including a link to a web page storing the digital experience. in some embodiments, the NFC tag 100 includes a memory 140 holding digital information including the digital experience. In some embodiments, the NFC tag 100 is configured to transmit the digital experience in response to being ready by a reader 150.

For example, where the object 1001 is a collectable card, the digital experience may display a history of the card, the “grade” of the card, and the ownership history of the card. In some embodiments, the digital experience includes a video showing the card being signed, for example by an athlete or other entertainer or performer who is the subject of the card. Other information in the digital experience could include one or more feature selected from among:
name of the item;
date and time of grading of the item;
brand or company that produced the item;
associations (professional sports leagues, cartoon or animation studios) associated with or describing the item;
image and/or video of the actual item;
image and/or video of a sample product;
serial number or any unique identifiers on the item; and
product SKU such as UPC barcodes or other standardized system identifying the item.

Some embodiments include in a digital experience content associated with, or conditional on, the status of a tag (e.g., whether the tag has been tampered-with). For example, in embodiments in which a tag 100 forms all or part of a seal of a container (e.g., by being affixed over an opening of the container), displaying or causing display of digital content may be conditioned on breaking of the seal, as detected by the tag 100. In other embodiments, displaying or causing display of digital content may be conditioned on a determination that the seal has not been broken, as detected by the tag 100. In one example, an entity (e.g., a brand) could create a sealed gift box where a welcome video or music or other digital content by an artist or sports star could be shown only after the seal is broken (e.g., conditioned upon the seal having been broken). In another example, an entity (e.g., a collectable item company) could include a message about how the tamper seals work only if the seal is intact, and alternatively displays an authentication warning if the seal is broken.

Some embodiments, program details of the object 1001 into the NFC chip 110 itself and encrypt it with a private key associated with the object, and/or associated with the container 1000. In some embodiments, the tag 100 has extra functionality to write arbitrary data and optionally encrypt/decrypt that data.

Some embodiments show the item details on a computer (e.g., via a web page linked to by the NFC tag) after it is verified by a server or blockchain.

In some embodiments, the web page is configured to show a photo or video of the item 1001 being sealed and graded so it matches what's inside the case 1010. In some embodiments, the web page lists each verification attempt on the webpage along with date, time, and optionally other identifiable information like IP address, username, etc., and derive data from the IP address such as approximate location.

In illustrative embodiments, upon breaking the wire of an NFC tag 100, the webpage content shows information to indicate that the tag 100 (e.g., the seal) has been tampered with.

In some embodiments, ownership of the item 1001 could be connected to an online account and be part of someone's collection viewable in their online profile.

In some embodiments, information such as that described above is printed on the NFC tag 100, for example using security ink or a set of holograms.

Various embodiments may be characterized by the potential claims listed in the paragraphs following this paragraph (and before the actual claims provided at the end of this application). These potential claims form a part of the written description of this application. Accordingly, subject matter of the following potential claims may be presented as actual claims in later proceedings involving this application or any application claiming priority based on this application. Inclusion of such potential claims should not be construed to mean that the actual claims do not cover the subject matter of the potential claims. Thus, a decision to not present these potential claims in later proceedings should not be construed as a donation of the subject matter to the public.

Without limitation, potential subject matter that may be claimed (prefaced with the letter “P” so as to avoid confusion with the actual claims presented below) includes:
P1. A method of authenticating a message from a near field communications (NFC) tag having a corresponding encryption key, comprising:
   receiving, at a reader via near field communication, a message from the NFC tag, the message comprising:
   an NFC tag identifier uniquely corresponding to the NFC tag;
   an item of variable data generated by the NFC tag; and
   an authentication code generated by the NFC tag from the tag identifier, and item of variable data, and the encryption key;
   reading the authentication code from the message, said authentication code being an extracted authentication code; and
   authenticating that the message is from the NFC tag by determining that the authentication code is from the NFC tag.
P2. The method of P1, wherein determining that the authentication code is from the NFC tag comprises:
   accessing a predetermined list of a plurality of authentication codes associated uniquely with the NFC tag, in which each authentication code could only have been generated from data including the NFC tag identifier and the item of variable data and the encryption key;
   confirming that the authentication code is included on the predetermined list.
P3. The method of P2, wherein the predetermined list of a plurality of authentication codes comprises a plurality of hashed authentication codes in an organized data structure, which data structure includes one of a database, a list, and a spreadsheet.
P4. The method of P2, wherein the predetermined list of a plurality of authentication codes comprises a Merkle tree having a plurality of leaves, wherein each leaf of the plurality of leaves corresponds uniquely to an authentication code associated uniquely with the NFC tag.
P11: A method of providing a reward to a party using an NFC tag reader to read an NFC tag, the method comprising:
   receiving, at a computer system from the NFC tag reader, notice that the NFC tag reader has authenticated a first message from a first NFC tag, said first message being an authenticated message having an associated first authentication code;
   validating, by the computer system, that the associated first authentication code has not been used previously to authenticate a message from said first NFC tag, said validation be a first validation; and
   in response to and contingent on said first validation, causing a reward to be provided to the party that used the NFC reader to read the message from the first NFC tag.
P12: The method of P11, wherein:
   the NFC tag is associated with a product from a product source; and
   causing a reward to be provided to the party using the NFC reader comprises causing said reward to be provided to the party from the product source.
P13. The method of any of P11-P12, further comprising:
   receiving, at the computer system from the NFC tag reader, notice that the NFC tag reader has authenticated a second message from a second NFC tag, said second message being a second authenticated message having an associated second authentication code;
   validating, by the computer system, that the associated second authentication code has not been used previously to authenticate a message from said second NFC tag, said validation being a second validation; and
   causing a reward to be provided to the party that used the NFC reader is further contingent on said second validation.
P14. The method of any of P11-P13, wherein the reward comprises an item selected from:
   a non-fungible token (“NFT”);
   one or more tokens;
   cryptocurrency;
   digital content such as music, movies, etc.;
   discount codes or digital coupons that are redeemable for something else, digital or physical;
   tickets and access (e.g., receiving a digital ticket to an in-person or access to a virtual event or community); and
   in-game content (e.g., digital items, characters, upgrades, or downloadable content within a game or other metaverse virtual experiences).
P21. A system for authenticating a message from a near field communications (NFC) tag having a corresponding encryption key, the system comprising:
   a processor coupled to an antenna to receive, via near field communication, the message from the NFC tag, the message comprising:
   an NFC tag identifier uniquely corresponding to the NFC tag;
   an item of variable data generated by the NFC tag; and
   an authentication code generated by the NFC tag from the tag identifier, and item of variable data, and the encryption key; and
   a memory holding a predetermined list of a plurality of authentication codes associated uniquely with the NFC tag, in which each authentication code could only have been generated from data including the NFC tag identifier and the item of variable data and the encryption key;
   wherein the processor is configured to authenticate that the message is from the NFC tag by determining that the authentication code is from the NFC tag.
P22. The system of P21, wherein the processor is configured to authenticate that the message is from the NFC tag by confirming that the authentication code is included on the predetermined list.
P23. The method of P21, wherein the predetermined list of a plurality of authentication codes comprises a plurality of hashed authentication codes in an organized data structure, which data structure includes one of a database, a list, and a spreadsheet.
P24. The system of P22, wherein the predetermined list of a plurality of authentication codes comprises a Merkle tree having a plurality of leaves, wherein each leaf of the plurality of leaves corresponds uniquely to an authentication code associated uniquely with the NFC tag.
P101. An apparatus for securely holding a collectable item, the apparatus comprising:
   a case having a closeable pouch defining an interior volume configured to hold the collectible item; and
   a tamper-detecting near field communications (“NFC”) tag secured to the case and configured to change a state in response to an opening of the case after the NFC tag has been applied, where the NFC tag is configured to transmit information indicating the change of state.
P102. The apparatus of P101, wherein:
   the tamper-detecting NFC tag is configured to provide output data in response to a query from an NFC reader, said output data comprising:
      first state data at a first time, which first time occurs after the NFC tag has been applied and before the case has been opened; and
      second state data at a second time, which second time occurs after the first time and after the case has been opened, wherein said second state data indicates that the case has been opened and is indicative of the change of state.
P103. The apparatus of any of P101-P102, wherein the case has a separate (second) pouch for holding the NFC tag within the case.
P104. The apparatus of any of P101-P103, wherein the NFC tag is disposed within the closeable interior pouch along with the collectable item.
P105. The apparatus of any of P101-P104, wherein the NFC tag is configured to detect opening of at least two edges or seams of the apparatus.
P106. The apparatus of any of P101-P105, wherein the apparatus includes a plurality of NFC tags to detect tampering of a corresponding plurality of edges or seams of the apparatus.
P107. The apparatus of any of P101-P106, wherein the NFC tag includes a wire that is long enough to be disposed near more than one edge or seam of the apparatus, which wire, when broken, causes the change in information transmitted by the tag in response to an inquiry from an NFC reader.
P108. The apparatus of any of P101-P107, wherein the NFC tag includes several wires so that each wire can be disposed near a corresponding edge or seam of the case, wherein each wire is in addition to the antenna, so that the antenna remains functional after the wire is broken.
P109: The apparatus of any of P101-P108, wherein the NFC tag is configured to cause display, on a computer screen in response to being read by a reader, of a digital experience, the digital experience including a set of information selected from:
   the name of the item in the apparatus;
   the date and time of grading of the item;
   the brand or company that produced the item;
   associations (e.g., professional sports leagues, cartoon or animation studios) associated with or describing the item;
   an image and/or video of the actual item;
   an image and/or video of a sample product;
   a serial number or any unique identifiers on the item;
   a product SKU such as UPC barcodes or other standardized system identifying the item;
   a photo or video of the item being sealed and graded so it matches what's inside the collectible case; and/or
   a list of each verification attempt along with date, time, and optionally other identifiable information like IP address, username, etc., and/or information derived from the IP address such as approximate location;
P110: The apparatus of any of P101-P109, wherein, the NFC tag seals the case and, upon breaking the seal, the digital experience shows information indicating that the seal has been tampered with.
P111: The apparatus of any of P101-P110, wherein ownership of the item is connected to an online account and is configured to be displayed to indicate that the item if part of someone's collection viewable in their online profile.
P112: The apparatus of any of P101-P111, wherein the NFC tag includes item information is printed on the NFC tag using security ink or holograms.
P113: The apparatus of any of P101-P112, wherein the NFC tag is configured to cause display, on a computer screen, of a digital experience after the tag, or a read of the tag, is verified by a server or blockchain.
P114: The apparatus of any of P101-P113, wherein the NFC tag is programmed to include item details, which details are encrypted with a private key.
P115: The apparatus of any of P101-P114, wherein the NFC tag has extra functionality to write arbitrary data and optionally encrypt/decrypt such data.
P116: The apparatus of any of P101-P115, wherein the NFC tag is configured to encrypt data using symmetric encryption and so is configured to transmit symmetrically encrypted information indicating the change of state.
P117: The apparatus of any of P101-P115, wherein the NFC tag is configured to encrypt data using asymmetric encryption and so is configured to transmit asymmetrically encrypted information indicating the change of state.
P121. An apparatus for securely holding a collectable item, the apparatus comprising:
   a case having a closeable opening defining an interior volume configured to hold the collectible item; and
   a wire disposed within the case, the wire having:
      a first end not coupled to a first bonding pad of an NFC tag but configured to electrically couple to said first bonding pad of an NFC tag, and
      a second end configured to electrically couple to a second bonding pad of an NFC tag,
   wherein when an NFC tag is coupled to the case to cover to the closeable opening, and the first end of the wire is electrically coupled to the first bonding pad and the second end of the wire is electrically coupled to the second bonding pad, and the NFC tag is configured to transmit information indicating a state of the NFC tag, a subsequent opening of the closeable opening causes a change in the NFC tag such that the NFC tag is configured to transmit information indicating that the closeable opening has been opened.
P122: The apparatus of P121, further comprising the features of any of P102-P115.
P151. A method of managing ownership of an item or enabling functionality from the ownership, the method comprising:
   receiving a digital signature from a signature generation device associated with an item;
   authenticating with an authentication device after obtaining the digital signature;
   transferring a digital token to a prescribed new owner after authenticating,
   the digital signature being different between at least two different times obtaining the digital signature from the signature generation device.
P152. The method of P151 wherein the signature generation device comprises an NFC device.
P153. The method of any one or more of P151-P152 wherein the digital token is formed as a blockchain element.
P154. The method of any one or more of P151-P153 wherein the digital signature is generated from a private key within the signature generation device.
P155. The method of any one or more of P151-P154 wherein the act of authenticating comprises scanning the signature generation device to obtain the digital signature.
P156. The method of any one or more of P151-P155 wherein the item comprises a physical item.
P157. A system configured to implement the method of any one or more of the methods of P151-P6.
P158. A non-transitory computer-readable medium having computer executable code thereon, the computer executable code, when executed by a computer system, causing the computer system to perform a method according to any of P151-P156.
P201. (1+3) A method comprising:
   receiving, at a first time and directly at a reader via near-field communication, a first message in question, the message in question comprising a first plurality of individual data items;
   extracting, by the reader from the first message in question, the first plurality of individual data items, said individual data items being first extracted data items;
   hashing the first extracted data items with a particular hashing algorithm to form a first signature in question; and
   authenticating, by the reader and on the reader, that the first message in question is from a particular NFC tag, which particular NFC tag is uniquely associated with a particular corresponding physical item, by:
      accessing a Merkle tree stored in memory of the reader, the Merkle tree comprising a plurality of leaves in which each leaf stores a hashed signature, each such hashed signature corresponding uniquely with the particular NFC tag in that each such hashed signature could only have been generated using the particular hashing algorithm and NFC tag data from the particular NFC tag, the NFC tag data comprising:
         (i) an NFC tag identifier (“UID”) uniquely corresponding to the particular NFC tag;
         (ii) an item of variable data generated by the particular NFC tag, the variable data having a value; and
         (iii) a CMAC generated from the NFC tag identifier and a value of the item of variable data and an encryption key;
   determining that the signature in question is on a leaf of said Merkle tree.
P202: The method of P201, wherein the value of item of variable data generated by the particular NFC tag comprises a discrete number selected from a set of discrete numbers between zero and 1,000,000.
P203: The method of any of P201-P202, wherein the particular NFC tag comprises a counter producing a counter output value and to increment the counter output value each time the NFC tag is read, which counter output value comprises the item of variable data.
P204: The method of any of P201-P203 in which the particular NFC tag is physically coupled to the particular corresponding physical item.
P205: The method of any of P201-P204, the method further comprising, subsequent to and consequent to authenticating that the first message in question is from the particular NFC tag, recording on a ledger a transfer of ownership of the particular corresponding physical item to the holder of the particular NFC tag.
P206 (+5): The method of any of P201-P204, the method further comprising, subsequent to authenticating that the first message in question is from the particular NFC tag, denying a recording of a transfer of ownership of the particular corresponding physical item to the holder of the particular NFC tag.
P207: The method of any of P201-P204, the method further comprising, subsequent to authenticating that the first message in question is from the particular NFC tag, permitting a recording of a transfer of ownership of the particular corresponding physical item to the holder of the particular NFC tag only if the holder of the particular NFC tag is a pre-approved recipient of the particular corresponding physical item.
P208 (+6): The method of P205, wherein:
   the holder of both the particular NFC tag and the particular corresponding physical item is an escrow agent, which escrow agent has graded the condition of the particular corresponding physical item; and wherein the method further comprises:
   subsequent to authenticating that the message in question is from the particular NFC tag, recording of a transfer of ownership of the particular corresponding physical item to the escrow agent; and
   transferring both the particular NFC tag and the particular corresponding physical item to purchaser of the particular corresponding physical item.
P209 (+7): The method of any of P201-P208, the method further comprising:
   receiving, directly at the reader via near-field communication, a second message in question comprising a second plurality of individual data items; and
   authenticating, by the reader and on the reader, that the second message in question is from a particular NFC tag.
P210: (+8) The method of any of P201-P209, wherein:
   receiving, directly at the reader via near-field communication, the message in question occurs at a first time, and wherein:
   authenticating, by the reader and on the reader, that the message in question is from the particular NFC tag must occur prior to a pre-determined second time, said pre-determined second time subsequent to and measured from the first time.
P211: (+9) The method of any of P201-P210, wherein the first plurality of individual data items comprises global positioning system data reporting a geographic location of the particular NFC tag, and the reader comprises a GPS received configured to determine the geographic location of the particular NFC tag, at the first time, from the global positioning system data.
P212: The method of any of P201-P211, wherein authenticating that the first message in question is from the particular NFC tag is performed without use of the encryption key.
P221. (1+4) A method comprising:
   authenticating a message from a near field communications (“NFC”) tag having a corresponding encryption key, the NFC tag uniquely associated with both a physical item and a corresponding non-fungible token (“NFT”) uniquely associated with the physical item, by:
      receiving, directly at a reader via near-field communication, a message directly from the NFC tag, the message comprising:
         (i) an NFC tag identifier uniquely corresponding to the NFC tag;
         (ii) an item of variable data generated by the NFC tag; and
         (iii) an authentication code generated by the NFC tag from the tag identifier, the item of variable data, and the encryption key;
      extracting the authentication code from the message, said authentication code being an extracted authentication code;
      authenticating that the message is from the NFC tag; and subsequent to and contingent on authenticating that the message is from the NFC tag:
      causing an action, the action relating to both the physical item and its corresponding non-fungible token.
P222: The method of P221, wherein the action comprises recording, in a leger, a change of ownership of the physical item and its corresponding non-fungible token.
P223: The method of P221, wherein the action comprises causing a reward to be provided to a party that caused the NFC reader to read the message directly from the NFC tag.
P301: A non-transitory computer-readable medium having computer executable code thereon, the computer executable code, when executed by a computer process on a near field communication reader, causing the computer processor to perform a method according to any of P201-P212 and P221-P223.
P401: An apparatus for securely holding an item, the apparatus comprising:
   a case having an interior volume configured to hold the item, and a closeable opening; and
   a first tamper-detecting near field communications (“NFC”) tag secured to the case and configured to provide output data in response to a query from an NFC reader, said output data comprising:
      first state data at a first time, which first time occurs after the NFC tag has been applied and before the case has been opened; and
      second state data at a second time, which second time occurs after the first time and after the case has been opened, wherein said second state data indicates that the case has been opened and is indicative of the change of state.
P402: The apparatus of P401, wherein the output data further comprises:
   (i) an NFC tag identifier (“UID”) uniquely corresponding to the first tamper-detecting near field communications (“NFC”) tag;
   (ii) an item of variable data generated by the to the first tamper-detecting near field communications (“NFC”) tag; and
   (iii) a CMAC generated from the NFC tag identifier and a value of the item of variable data and an encryption key.
P403: The apparatus of P402, wherein the value of item of variable data generated by the particular NFC tag comprises a discrete number selected from a set of discrete numbers between zero and 1,000,000.
P404: The apparatus of any of P401-P403, wherein the first tamper-detecting near field communications (“NFC”) tag comprises a counter producing a counter output value and to increment the counter output value each time the NFC tag is read, which counter output value comprises the item of variable data.
P405: The apparatus of any of P401-P404, wherein the output data further comprises: global positioning system data reporting a geographic location of the first tamper-detecting near field communications (“NFC”) tag at a time that the first tamper-detecting near field communications (“NFC”) responds to a query from an NFC reader.
P406. The apparatus of any of P401-P405, wherein the case has a pouch for holding the first tamper-detecting NFC tag within the case, said pouch distinct from the interior volume.
P407. The apparatus of any of P401-P406, wherein the case has a plurality of sides, and: the first tamper-detecting NFC tag is disposed to detect opening of a first side of the case; and the apparatus further comprises:
   a second tamper-detecting near field communications (“NFC”) tag secured to the case and disposed to detect opening of a second side of the case, the second side distinct from the first side.
P408. The apparatus of any of P401-P407, wherein the case has a plurality of sides, and the first tamper-detecting NFC tag is disposed on the case so as to be configured to detect opening of at least two edges or seams of the case.
P409. The apparatus of any of P401-P408, wherein the first tamper-detecting NFC tag includes a wire configured to be disposed at an edge of the case, which wire, when broken, causes the first tamper-detecting NFC tag to change its output data to indicate a change of state from a first state data to a second state.
P410. The apparatus of any of P401-P409, wherein the first tamper-detecting NFC tag includes a wire configured to be disposed at a plurality of edges of the case, which wire, when broken, causes the first tamper-detecting NFC tag to change its output data from a first state to second state.
P411. The apparatus of any of P401-P410, wherein the first tamper-detecting NFC tag includes a plurality of wires, each wire configured to be disposed near a corresponding edge or seam of the case, each wire when broken, causes the first tamper-detecting NFC tag to change its output data from first state data to second state data.
P412. The apparatus of any of P401-P411, wherein the first tamper-detecting NFC tag is disposed within the interior volume along with the item.
P413. The apparatus of any of P401-P412, wherein the first tamper-detecting NFC tag is configured to cause a reader to cause display, on a computer screen in response to the tamper-detecting NFC tag being read by the reader, of a digital experience, the digital experience including information describing an item confined within the interior volume.
P414. The apparatus of P413, wherein information describing the item comprises a name of the item confined within the interior volume.
P415. The apparatus of P413, wherein information describing the item comprises an image of the item confined within the interior volume.
P416. The apparatus of P413, wherein the item confined within the interior volume is a collectable item and the information describing the item comprises an association of the collectable item with a celebrity.
P417. The apparatus of P413, wherein the information describing the item confined within the interior volume comprises a photograph of an act of sealing the item into the interior volume.
P418. The apparatus of P413, wherein the information describing the item confined within the interior volume comprises a video of an act of sealing the item into the interior volume.

Various embodiments of this disclosure may be implemented at least in part in any conventional computer programming language. For example, some embodiments may be implemented in a procedural programming language (e.g., “C”), or in an object-oriented programming language (e.g., “C++”), or in Python, R, Java, LISP, or Prolog. Other embodiments of this disclosure may be implemented as preprogrammed hardware elements (e.g., application specific integrated circuits, FPGAs, and digital signal processors), or other related components.

In an alternative embodiment, the disclosed apparatus and methods may be implemented as a computer program product for use with a computer system. Such implementation may include a series of computer instructions fixed either on a tangible medium, such as a non-transitory computer readable medium (e.g., a diskette, CD-ROM, ROM, FLASH memory, or fixed disk). The series of computer instructions can embody all or part of the functionality previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of this disclosure may be implemented as a combination of both software (e.g., a computer program product) and hardware. Still other embodiments of this disclosure are implemented as entirely hardware, or entirely software.

Computer program logic implementing all or part of the functionality previously described herein may be executed at different times on a single processor (e.g., concurrently) or may be executed at the same or different times on multiple processors and may run under a single operating system process/thread or under different operating system processes/threads. Thus, the term “computer process” refers generally to the execution of a set of computer program instructions regardless of whether different computer processes are executed on the same or different processors and regardless of whether different computer processes run under the same operating system process/thread or different operating system processes/threads.

The embodiments described above are intended to be merely exemplary; numerous variations and modifications will be apparent to those skilled in the art. All such variations and modifications are intended to be within the scope of the present disclosure as defined in any appended claims.

What is claimed is:

1. An apparatus for securely holding an item, the apparatus comprising:
a case having an interior volume configured to hold the item, and a closeable opening; and
a first tamper-detecting near field communications (“NFC”) tag secured to the case and configured to provide output data in response to a query from an NFC reader, said output data comprising:
first state data at a first time, which first time occurs after the NFC tag has been applied and before the case has been opened; and
second state data at a second time, which second time occurs after the first time and after the case has been opened, wherein said second state data indicates that the case has been opened and is indicative of the change of state.

2. The apparatus of claim 1, wherein the case has a pouch for holding the first tamper-detecting NFC tag within the case, said pouch distinct from the interior volume.

3. The apparatus of claim 1, wherein the case has a plurality of sides, and:
the first tamper-detecting NFC tag is disposed to detect opening of a first side of the case; and the apparatus further comprises:
a second tamper-detecting near field communications (“NFC”) tag secured to the case and disposed to detect opening of a second side of the case, the second side distinct from the first side.

4. The apparatus of claim 1, wherein the case has a plurality of sides, and the first tamper-detecting NFC tag is disposed on the case so as to be configured to detect opening of at least two edges or seams of the case.

5. The apparatus of claim 1, wherein the first tamper-detecting NFC tag includes a wire configured to be disposed at an edge of the case, which wire, when broken, causes the first tamper-detecting NFC tag to change its output data to indicate a change of state from a first state data to a second state.

6. The apparatus of claim 1, wherein the first tamper-detecting NFC tag includes a wire configured to be disposed at a plurality of edges of the case, which wire, when broken, causes the first tamper-detecting NFC tag to change its output data from a first state to second state.

7. The apparatus of claim 1, wherein the first tamper-detecting NFC tag includes a plurality of wires, each wire configured to be disposed near a corresponding edge or seam of the case, each wire when broken, causes the first tamper-detecting NFC tag to change its output data from first state data to second state data.

8. The apparatus of claim 1, wherein the first tamper-detecting NFC tag is disposed within the interior volume along with the item.

9. The apparatus of claim 1, wherein the first tamper-detecting NFC tag is configured to cause a reader to cause display, on a computer screen in response to the tamper-detecting NFC tag being read by the reader, of a digital experience, the digital experience including information describing an item confined within the interior volume.

10. The apparatus of claim 9, wherein information describing the item comprises a name of the item confined within the interior volume.

11. The apparatus of claim 9, wherein information describing the item comprises an image of the item confined within the interior volume.

12. The apparatus of claim 9, wherein the item confined within the interior volume is a collectable item and the information describing the item comprises an association of the collectable item with a celebrity.

13. The apparatus of claim 9, wherein the information describing the item confined within the interior volume comprises a photograph of an act of sealing the item into the interior volume.

14. The apparatus of claim 9, wherein the information describing the item confined within the interior volume comprises a video of an act of sealing the item into the interior volume.

15. An apparatus for securely holding an item, the apparatus comprising:
a case having a closeable opening defining an interior volume, said volume configured to hold the item when the opening is in a closed state; and
a wire disposed within the case, the wire having:
a first end not coupled to a first bonding pad of an NFC tag but configured to electrically couple to said first bonding pad of an NFC tag, and
a second end configured to electrically couple to a second bonding pad of the NFC tag,
wherein the wire is configured to configure the NFC tag into a tamper-detecting NFC tag by providing an electrical connection between the first bonding pad and the second bonding pad.

16. The apparatus of claim 15 wherein when the NFC tag is coupled to the case to cover to the closeable opening, and the first end of the wire is electrically coupled to the first bonding pad and the second end of the wire is electrically coupled to the second bonding pad, the NFC tag is configured to transmit information indicating a subsequent opening of the closeable opening.

17. The apparatus of claim 15, wherein the wire configured to be disposed at a plurality of edges of the case so as to detect opening of the case at any of said edges.

18. The apparatus of claim 15, wherein the wire is configured to couple to a particular NFC tag, which particular NFC tag is specifically associated with a particular item disposed within the interior volume.

19. The apparatus of claim 18, wherein the particular NFC tag is configured to cause a reader to cause display, on a computer screen in response to being read by the reader, of a digital experience, the digital experience including information describing the particular item.

20. The apparatus of claim 18, wherein the particular NFC tag comprises a memory storing information identifying an owner of the particular item, and the digital experience includes said information identifying said owner of the particular item.
